(19) United States
(12) Patent Application Publication
(10) Pub. No.: US 2016/0229955 A1
(43) Pub. Date: Aug. 11, 2016

(54) BRANCHED POLYETHER CARBONATE POLYOLS AND PROCESS FOR PREPARATION THEREOF

(71) Applicant: COVESTRO DEUTSCHLAND AG, Leverkusen (DE)

(72) Inventors: Thomas E. MÜLLER, Aachen (DE); Christoph GÜRTLER, Köln (DE); Muhammad A. SUBHANI, Aachen (DE); Burkhard KÖHLER, Zierenberg (DE)

(21) Appl. No.: 15/022,714

(22) PCT Filed: Sep. 15, 2014
(86) PCT No.: PCT/EP2014/069578

§ 371 Date: Mar. 17, 2016

(30) Foreign Application Priority Data
Sep. 20, 2013 (EP) 13185411.9

(51) Int. Cl. C08G 65/26; C08G 18/48; C08G 18/72

(52) U.S. Cl. CPC C08G 65/2609; C08G 18/72; C08G 18/48; C08G 65/2663

(57) ABSTRACT

The present invention relates to a process for preparing branched polyether carbonate polyols, comprising the step of reacting an alkylene oxide and carbon dioxide with an H-functional starter compound in the presence of a catalyst, wherein the reaction is additionally conducted in the presence of a branching compound comprising a functional group polymerizable by ring-opening and an H-functional group. The branching compound is added during the reaction in such a way that the proportion of the branching compound in the reaction mixture obtained, at any time during the addition, is <=7.5% by weight, based on the amount of H-functional starter compound, alkylene oxide and branching compound added at this time. The invention further relates to a polyether carbonate polyol preparable by the process according to the invention, and to crosslinked polyether carbonate polymers based thereon.

The present invention relates to a process for preparing branched polyethercarbonate polyols, comprising the step of reacting an alkylene oxide and carbon dioxide with an H-functional starter compound in the presence of a catalyst, wherein the reaction is additionally conducted in the presence of a branching compound comprising a functional group polymerizable by ring opening and an H-functional group. It further relates to a polyethercarbonate polyol preparable by the process of the invention and to crosslinked polyethercarbonate polymers based thereon.

As well as having a tailored functionality, modern plastics are also intended to do increased justice to environmental concerns. As well as by a general optimization of preparation processes, this can also be achieved through the use of greenhouse gases, such as carbon dioxide, as building blocks for the synthesis of polymers. Accordingly, for example, a better environmental balance for the process can be obtained overall via the fixing of carbon dioxide. This path is being followed in the area of the production of polyethercarbonates, and has been a topic of intense research for more than 40 years (e.g., Inoue et al, Copolymerization of Carbon Dioxide and Alkylenoxide with Organometallic Compounds; Die Makromolekulare Chemie 130, 210-220, 1969). In one possible preparation variant, polyethercarbonate polyols are obtained by a catalytic reaction of alkylene oxides and carbon dioxide in the presence of H-functional starter compounds (“starters”). A general reaction equation for this is:

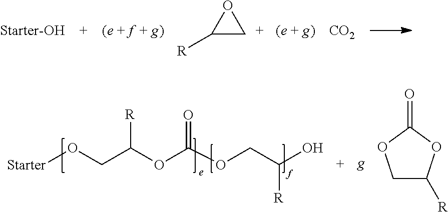

A further product, in this case an unwanted byproduct, arising alongside the polyethercarbonate polyol is a cyclic carbonate (for example, for R═CH₃, propylene carbonate).

The literature describes a number of different preparation variants. For example, US 2010/0048935 A1 describes a process for preparing polyethercarbonate polyols by reacting alkylene oxides and carbon dioxide with H-functional starter compounds by means of a DMC catalyst, in which one or more starter compounds are initially charged in a reactor and, in addition, one or more starter compounds are metered in continuously over the course of the reaction. One possible alkylene oxide mentioned is epoxidized soya oil. However, the reactivity of these oxirane rings is low, since they are within a chain and are highly sterically shielded. Therefore, epoxidized soya oil is converted inure slowly than standard monomers, such as propylene oxide, and accumulates in the reaction mixture. Since epoxidized soya oil, moreover, is a mixture of polyepoxidized compounds, controlled construction of defined polymer architectures is impossible.

WO 2006/103213 A1, in contrast, describes a process for preparing polyethercarbonate polyols that features improved incorporation of CO₂ into the polyethercarbonate polyol, using a catalyst containing a multimetal cyanide. The document discloses the presence of an H-functional starter compound, an alkylene oxide, and carbon dioxide in the presence of the multimetal cyanide component in a reactor. The document further discloses the presence of a CO₂-philic substance or of CO₂-philic substituents. The CO₂-philic substance or the CO₂-philic substituent is intended to facilitate the incorporation of CO₂ into the polyethercarbonate polyol and so to reduce the formation of cyclic alkylene carbonates, such as propylene carbonate, for example, which represent unwanted byproducts.

WO 2012/130760 mentions the use of higher-functionality alcohols as starter compound in the reaction of alkylene oxides with CO₂ to give polyethercarbonates under double metal cyanide (DMC) catalysis. Polyethercarbonate polyols prepared with higher-functionality starter compounds, given the same OH number, have a viscosity that rises with functionality. Accordingly, EP 12181907, for a polyethercarbonate obtained using glycerol as trifunctional starter compound, describes a significantly increased viscosity (36.0 Pa·s) in comparison with a polyethercarbonate obtained using dipropylene glycol as difunctional starter compound (4.1 Pa·s).

Use of glycidol as comonomer in the preparation of polyethers is described, for example, in GB 1586520. Thus, a polymer described therein may be a copolymer of an alkylene oxide and glycidol and optionally a glycidyl ester of a fatty acid or a polycarboxylic acid. Catalysts used for the preparation of such polyethers are acidic compounds, preferably sulfonic acids. There is no mention of the use of CO₂ as comonomer.

The functionality of the polyethercarbonate polyols obtained is determined by the functionality of the alcohol used as starter compound. Such starter compounds often have to be synthesized in a separate step. The synthesis of the starter compounds from a low molecular weight polyalcohol and an alkylene oxide is usually effected using bases as catalyst. Before these starter compounds are used in catalysis with DMC catalysts, they have to be purified in a complex manner to free them of basic catalyst residues, in order to avoid deactivation of the catalyst. However, the viscosity of the products obtained is frequently nevertheless elevated.

None of the documents cited explains how a lowered activity or a deactivation of the DMC catalyst used by glycidol can be avoided. There is no discussion of effects on the viscosity of the product mixtures obtained and the reactivity of the OH groups.

What would therefore be desirable would be a process for preparing low-viscosity branched and hence higher-functionality polyethercarbonate polyols which exhibit maximum reactivity of the end groups and rapid curing in the subsequent reaction with crosslinking reagents. This will open up new fields of use for such branched polyethercarbonate polyols.

The problem addressed by the present invention is that of providing such a process. This problem is solved in accordance with the invention by a process for preparing branched polyethercarbonate polyols, comprising the step of reacting an alkylene oxide and carbon dioxide with an H-functional starter compound in the presence of a catalyst, wherein the reaction is additionally conducted in the presence of a branching compound comprising a functional group polymerizable by ring opening and an H-functional group and wherein the branching compound is added during the reaction in such a way that the proportion of branching compound in the reaction mixture obtained is 7.5% by weight at any time during the addition, based on the amount of H-functional starter compound, alkylene oxide and branching compound added at this time.

It has been found that, surprisingly, branched polyethercarbonate polyols can be prepared, where the incorporation of a branching molecule during the polymerization reaction leads in each case to branching of the polymer chain with introduction of a further functional end group. Gelation of the reaction mixture can be avoided by using branching compounds comprising exactly one functional group polymerizable by ring opening and at least one H-functional group per molecule. The average functionality of the polyethercarbonate polyol obtained can be adjusted via the amount of the branching compound used. In addition, the polyethercarbonate polyols obtained have a surprisingly low viscosity and a high reactivity of the H-functional (Zerewitinoff-active) end groups toward isocyanates.

By the nature of the branches in the polymer, the polyethercarbonate polyols obtainable by the process according to the invention may, without restriction thereto, be referred to as “star-branched”, “highly branched” or “dendrimeric”.

Suitable alkylene oxides (epoxides) are, for example, one or more compounds selected from the group consisting of ethylene oxide, propylene oxide, 1-butene oxide, 2,3-butene oxide, 2-methyl-1,2-propene oxide (isobutene oxide), 1-pentene oxide, 2,3-pentene oxide, 2-methyl-1,2-butene oxide, 3-methyl-1,2-butene oxide, 1-hexene oxide, 2,3-hexene oxide, 3,4-hexene oxide, 2-methyl-1,2-pentene oxide, 4-methyl-1,2-pentene oxide, 2-ethyl-1,2-butene oxide, 1-heptene oxide, 1-octene oxide, 1-nonene oxide, 1-decene oxide, 1-undecene oxide, 1-dodecene oxide, 4-methyl-1,2-pentene oxide, butadiene monoxide, isoprene monoxide, cyclopentene oxide, cyclohexene oxide, cycloheptene oxide, cyclooctene oxide, styrene oxide, methylstyrene oxide, pinene oxide, singly epoxidized fats in the form of mono-, di-, and triglycerides, singly epoxidized fatty acids, C1-C24 esters of singly epoxidized fatty acids, singly epoxidized derivatives of glycidol such as, for example, methyl glycidyl ether, ethyl glycidyl ether, 2-ethylhexyl glycidyl ether, allyl glycidyl ether, glycidyl methacrylate, and also epoxy-functional alkoxysilanes such as, for example, 3-glycidyloxypropyltrimethoxysilane, 3-glycidyloxypropyltriethoxysilane, 3-glycidyloxypropyltripropoxysilane, 3-glycidyloxypropylmethyldimethoxysilane, 3-glycidyloxypropylethyldiethoxysilane or 3-glycidyloxypropyltriisopropoxysilane.

As suitable H-functional starter compounds (starters) it is possible to use compounds having H atoms that are active in respect of the alkoxylation. Groups which have active H atoms and are active in respect of the alkoxylation are, for example, —OH, —NH₂ (primary amines), —NH— (secondary amines), —SH and —CO₂H, preferably —OH and —NH₂, especially preferably —OH. The compounds employed as H-functional starter compound are, for example, one or more compounds selected from the group consisting of mono- or polyhydric alcohols, polyfunctional amines, polyfunctional thiols, amino alcohols, thio alcohols, hydroxy esters, polyether polyols, polyester polyols, polyesterether polyols, polyethercarbonate polyols, polycarbonate polyols, polycarbonates, polyethylenimines, polyetheramines (e,g., so-called Jeffamines® from Huntsman, such as e.g. D-230, D-400, D-2000, T-403, T-3000, T-5000 or corresponding products from BASF, such as e.g. Polyetheramine D230, D400, D200, T403, T5000), polytetrahydrofurans (e.g., PolyTHF® from BASF, such as e.g. PolyTHF® 250, 650S, 1000, 1000S, 1400, 1800, 2000), polytetrahydrofuranamines (BASF product Polytetrahydrofuranamine 1700), polyetherthiols, polyacrylate polyols, castor oil, the mono- or diglyceride of ricinoleic acid, monoglycerides of fatty acids, chemically modified mono-, di- and/or triglycerides of fatty acids, and C1-C24 alkyl fatty acid esters which contain on average at least 2 OH groups per molecule. The C1-C24 alkyl fatty acid esters which contain on average at least 2 OH groups per molecule are, by way of example, commercial grades such as Lupranol Balance® (from BASF AG), Merginol® grades (from Hobum Oleochemicals GmbH), Sovermol® grades (from Cognis Deutschland GmbH & Co. KG), and Soyol® TM grades (from USSC Co.).

Monofunctional starter compounds used may be alcohols, amines, thiols and carboxylic acids. Monofunctional alcohols used may be: methanol, ethanol, 1-propanol, 2-propanol, 1-butanol, 2-butanol, tert-butanol, 3-buten-1-ol, 3-butyn-1-ol, 2-methyl-3-buten-2-ol, 2-methyl-3-butyn-2-ol, propargyl alcohol, 2-methyl-2-propanol, 1-tert-butoxy-2-propanol, 1-pentanol, 2-pentanol, 3-pentanol, 1-hexanol, 2-hexanol, 3-hexanol, 1-heptanol, 2-heptanol, 3-heptanol, 1-octanol, 2-octanol, 3-octanol, 4-octanol, phenol, 2-hydroxybiphenyl, 3-hydroxybiphenyl, 4-hydroxybiphenyl, 2-hydroxypyridine, 3-hydroxypyridine, 4-hydroxypyridine. Useful monofunctional amines include: butylamine, tert-butylamine, pentylamine, hexylamine, aniline, aziridine, pyrrolidine, piperidine, morpholine. Monofunctional thiols used may be: ethanethiol, 1-propanethiol, 2-propanethiol, 1-butanethiol, 3-methyl-1-butanethiol, 2-butene-1-thiol, thiophenol. Monofunctional carboxylic acids include: formic acid, acetic acid, propionic acid, butyric acid, fatty acids such as stearic acid, palmitic acid, oleic acid, linoleic acid, linolenic acid, benzoic acid, acrylic acid.

Polyhydric alcohols with suitability as H-functional starter compounds are, for example, dihydric alcohols (such as, for example, ethylene glycol, diethylene glycol, propylene glycol, dipropylene glycol, 1,3-propanediol, 1,4-butanediol, 1,4-butenediol, 1,4-butynediol, neopentyl glycol, 1,5-pentantanediol, methylpentanediols (such as, for example, 3-methyl-1,5-pentanediol), 1,6-hexanediol; 1,8-octanediol, 1,10-decanediol, 1,12-dodecanediol, bis(hydroxymethyl)cyclohexanes (such as, for example, 1,4-bis(hydroxymethyl)cyclohexane), triethylene glycol, tetraethylene glycol, polyethylene glycols, dipropylene glycol, tripropylene glycol, polypropylene glycols, dibutylene glycol, and polybutylene glycols); trihydric alcohols (such as, for example, trimethylolpropane, glycerol, trishydroxyethyl isocyanurate, castor oil); tetrahydric alcohols (such as, for example, pentaerythritol); polyalcohols (such as, for example, sorbitol, hexitol, sucrose, starch, starch hydrolyzates, cellulose, cellulose hydrolyzates, hydroxy-functionalized fats and oils, especially castor oil), and also all products of modification of these aforementioned alcohols with different amounts of ε-caprolactone.

The H-functional starter compounds may also be selected from the substance class of the polyether polyols, especially those having a molecular weight Mₙ in the range from 100 to 4000 g/mol. Preference is given to polyether polyols formed from repeat ethylene oxide and propylene oxide units, preferably having a proportion of propylene oxide units of 35% to 100%, particularly preferably having a proportion of propylene oxide units of 50% to 100%. These may be random copolymers, gradient copolymers, alternating copolymers or block copolymers of ethylene oxide and propylene oxide. Suitable polyether polyols formed from repeat propylene oxide and/or ethylene oxide units are, for example, the Desmophen®, Acclaim®, Arcol®, Baycoll®, Bayfill®, Bayflex®, Baygal®, PET® and polyether polyols from Bayer MaterialScience AG (for example Desmophen® 3600Z, Desmophen® 1900U, Acclaim® Polyol 2200, Acclaim® Polyol 40001, Arcol® Polyol 1004, Arcol® Polyol 1010, Arcol® Polyol 1030, Arcol® Polyol 1070, Baycoll® BD 1110, Bayfill® VPPU 0789, Baygal® K55, PET® 1004, Polyether® S180). Further suitable homopolyethylene oxides are, for example, the Pluriol® E products from BASF SE, suitable homopolypropylene oxides are, for example, the Pluriol® P products from BASE SE; suitable mixed copolymers of ethylene oxide and propylene oxide are, for example, the Pluronic® PE or Pluriol® RPE products from BASE SE.

The H-functional starter compounds may also be selected from the substance class of the polyester polyols, especially those having a molecular weight M in the range from 200 to 4500 g/mol. The polyester polyols used are at least difunctional polyesters. Preferably, polyester polyols consist of alternating acid and alcohol units. The acid components used are, for example, succinic acid, maleic acid, maleic anhydride, adipic acid, phthalic anhydride, phthalic acid, isophthalic acid, terephthalic acid, tetrahydrophthalic acid, tetrahydrophthalic anhydride, hexahydrophthalic anhydride or mixtures of the acids and/or anhydrides mentioned. Examples of alcohol components used include ethanediol, 1,2-propanediol, 1,3-propanediol, 1,4-butanediol, 1,5-pentanediol, neopentyl glycol, 1,6-hexanediol, 1,4-bis(hydroxymethyl)cyclohexane, diethylene dipropylene glycol, trimethylolpropane, glycerol, pentaerythritol, or mixtures of the stated alcohols. Employing dihydric or polyhydric polyether polyols as the alcohol component affords polyester ether polyols which can likewise serve as starter compounds for preparation of the polyethercarbonate polyols. Preference is given to using polyether polyols with Mₙ=150 to 2000 g/mol for preparation of the polyester ether polyols.

As H-functional starter compounds it is possible, furthermore, to use polycarbonate diols, more particularly those having a molecular weight Mₙ in the range from 150 to 4500 g/mol, preferably 500 to 2500 g/mol, which are prepared, for example, by reaction of phosgene, dimethyl carbonate, diethyl carbonate or diphenyl carbonate with difunctional alcohols or polyester polyols or polyether polyols. Examples relating to polycarbonates are found for example in EP-A 1359177. As polycarbonate diols it is possible for example to use the Desmophen® C grades from Bayer MaterialScience AG, such as Desmophen® C 1100 or Desmophen® C 2200, for example.

In a further embodiment of the invention, it is possible to use polyethercarbonate polyols as H-functional starter compounds. More particularly, polyethercarbonate polyols obtainable by the process according to the invention described here are used. For this purpose, these polyethercarbonate polyols used as H-functional starter compounds are prepared in a separate reaction step beforehand.

The H-functional starter compounds generally have an OH functionality (i.e., number of polymerization-active H atoms per molecule) of 1 to 8, preferably of 2 to 6, and more preferably of 2 to 4. The H-functional starter compounds are used either individually or as a mixture of at least two H-functional starter compounds.

Preferred H-functional starter compounds are alcohols of the general formula:

HO—(CH₂)ₓ—OH

where x is a number from 1 to 20, preferably an integer from 2 to 20. Examples of alcohols of the formula above are ethylene glycol, 1,4-butanediol, 1,6-hexanediol, 1,8-octanediol, 1,10-decanediol, and 1,12-dodecanediol. Further preferred H-functional starter compounds are neopentyl trimethylolpropane, glycerol, pentaerythritol, reaction products of the alcohols of the above formula with ε-caprolactone, e.g. reaction products of trimethylolpropane with ε-caprolactone, reaction products of glycerol with ε-caprolactone, and reaction products of pentaerythritol with ε-caprolactone. Preference is further given to using, as H-functional starter compounds, water, diethylene dipropylene glycol, castor oil, sorbitol and polyether polyols formed from repeating polyalkylene oxide units, and polyethercarbonate polyols.

With particular preference the H-functional starter compounds are one or more compounds selected from the group consisting of ethylene glycol, propylene glycol, 1,3-propanediol, 1,3-butanediol, 1,4-butanediol, 1,5-pentanediol, 2-methylpropane-1,3-diol, neopentyl 1,6-hexanediol, diethylene glycol, dipropylene glycol, glycerol, trimethylolpropane, di- and trifunctional polyether polyols, the polyether polyol being formed from a di- or tri-H-functional starter compound and propylene oxide or from a di- or tri-H-functional starter compound, propylene oxide, and ethylene oxide, and also di- and trifunctional polyethercarbonate polyols, the polyethercarbonate polyol being formed from a di- or tri-H-functional starter compound, carbon dioxide, and propylene oxide and/or ethylene oxide. The polyether polyols and polyethercarbonate polyols preferably have an OH functionality of 2 to 4 and a molecular weight M in the range from 62 to 4500 g/mol and more particularly a molecular weight M in the range from 62 to 3000 g/mol.

The catalyst used may be a DMC catalyst (double metal cyanide catalyst). Additionally or alternatively it is also possible to use other catalysts for the copolymerization of alkylene oxides and CO₂, such as zinc carboxylates or cobalt-salen complexes. Examples of suitable zinc carboxylates are zinc salts of carboxylic acids, especially dicarboxylic acids, such as adipic acid or glutaric acid. An overview of the known catalysts for the copolymerization of alkylene oxides and CO₂ is provided for example by Chemical Communications 47 (2011) 141-163.

It is likewise envisaged in accordance with the invention that the reaction to give polyethercarbonate polyols is additionally conducted in the presence of a branching compound comprising a functional group polymerizable by ring opening and an H-functional group.

Preferably, the branching compounds contain exactly one polymerizable group and at least one Zerewitinoff-active starter function. Thus, no gelation of the reaction mixture in the course of preparation of the polyethercarbonate polyols is to be expected.

Examples of functional groups polymerizable by ring opening in the branching compound are epoxides, oxetanes, aziridines, aliphatic lactones, aromatic lactones, lactides, cyclic carbonates having at least three optionally substituted methylene groups between the oxygen atoms of the carbonate group, aliphatic cyclic anhydrides and aromatic cyclic anhydrides.

Functional groups suitable for the alkoxylation and having active hydrogen atoms in the branching compound (H-functional groups) are especially —OH, —NH₂ (primary amines), —NH— (secondary amines), —SH, —CO₂H and β-dicarbonyl compounds.

In the process of the invention the branching compound is added during the reaction in such a way that the proportion of branching compound in the reaction mixture obtained is ≦7.5% by weight at any time during the addition, based on the amount of H-functional starter compound, alkylene oxide and branching compound added at this time. This proportion is preferably ≧0.1% by weight to ≧7.5% by weight, more preferably ≧0.5% by weight to ≦7% by weight and especially preferably ≧1% by weight to ≦5% by weight. In a continuously operated process, the branching compound is added in such a way that the proportion of branching compound in the reaction mixture obtained is ≦7.5% by weight at any time, based on the amount of H-functional starter compound, polyethercarbonate polyol, alkylene oxide and branching compound present in the reactor at this time. This proportion is preferably ≧0.1% by weight to ≦7.5% by weight, more preferably ≧0.5% by weight to ≦7% by weight and especially preferably ≧1% by weight to ≦5% by weight. Without being tied to a theory, it is assumed that inhibition or deactivation of the catalyst occurs in the case of higher proportions.

The average number of branching sites per polyethercarbonate polyol molecule arises from the functionality and the molar ratio of the branching compound used to starter compound. The amount of branching compound is chosen such that the calculated average functionality F of the branched polyethercarbonate polyol obtained is 2<F<22, preferably 2<F<11 and more preferably 2<F<4, in the case of use of a monofunctional starter compound and a branching compound containing exactly one polymerizable group and exactly one Zerewitinoff-active starter function, this corresponds to an average incorporation of 1-21 mol of the branching compound per mole of macromolecules, preferably of 1-10 mol of the branching compound per mole of macromolecules and more preferably of 1-3 mol of the branching compound per mole of macromolecules. In the ease of use of a &functional starter compound and a branching compound containing exactly one polymerizable group and exactly one Zerewitinoff-active starter function, this corresponds to an average incorporation of 0-20 mol of the branching compound per mole of macromolecules, preferably of 0-9 mol of the branching compound per mole of macromolecules and more preferably of 0-2 mol of the branching compound per mole of macromolecules. This amount of branching compound has been found to be particularly suitable for obtaining a relatively high functionality of the polyethercarbonate polyol molecules at a moderate to low viscosity of the polyethercarbonate polyols. The low viscosity of the higher-functionality polyethercarbonate polyols obtainable by the process of the invention additionally assures good further processibility of the polymers with, for example, fast conversions in the context of further crosslinking reactions. These specified ranges of average functionality can accordingly contribute to preferred mechanical properties of the shaped bodies or layers obtainable therefrom. The ratio of branching compound to starter compound in the branched polyethercarbonate polyol can be determined, for example, via NMR spectroscopy and analysis of the intensities of the characteristic signals for incorporated branching compound and extended starter compound.

Embodiments and further aspects of the present invention are elucidated hereinafter. They can be combined with one another as desired, unless the opposite is clear from the context.

For instance, at least one of the branching compounds may correspond to the following formula:

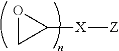

where

Z is an OH, NHR, COOH or C(O)CHRC(O)R group with

R=hydrogen, C1-C22 alkyl, cycloalkyl, aralkyl, aryl,

X is a chemical bond or a divalent or polyvalent, heteroatom-containing or non-heteroatom-containing C1-C22 aliphatic, cycloaliphatic, araliphatic or aromatic radical and

n is an integer≧1.

In a preferred configuration, at least one of the branching compounds may correspond to the following formula:

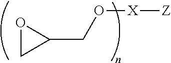

where X, Z and n are as defined above.

In a further configuration, at least one of the branching compounds may correspond to the following formula:

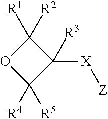

where

Z is an OH, NHR, COOH or C(O)CHRC(O)R group with

R=hydrogen, C1-C22 alkyl, cyclo alkyl, aralkyl, aryl.

X is a chemical bond or a divalent or polyvalent, heteroatom-containing or non-heteroatom-containing C1-C22 aliphatic, cycloaliphatic, araliphatic or aromatic radical and

R¹, R², R³, R⁴, R⁵ are independently hydrogen, C1-C22 alkyl, cycloalkyl, aralkyl, aryl, and the R¹, R², R³, R⁴, R⁵ radicals optionally contain heteroatoms,

Preferably, R¹, R² R³, R⁴ are hydrogen and R³ is methyl or ethyl.

In one embodiment of the process of the invention, the latter comprises the steps of:
(α) initially charging the catalyst and:
   a suspension medium which contains no H-functional groups and/or
   the H-functional starter compound
(γ) metering in carbon dioxide, the alkylene oxide and the branching compound.

wherein, additionally, if no H-functional starter compound has been initially charged in step (α), step (γ) comprises the metering-in of the H-functional starter compound.

Preferably, this embodiment further comprises step (β) between step (α) and step (γ):
(β) metering in an alkylene oxide which is the same as or different than the alkylene oxide which is used in step (γ).

Where a DMC catalyst is discussed in the remarks which follow, merely preferred embodiments are outlined. The remarks of course apply to all catalysts usable in accordance with the invention.

Step (α):

The DMC catalyst is preferably used in an amount such that the amount of DMC catalyst in the resulting polyethercarbonate polyol is 10 to 10 000 ppm, more preferably 20 to 5000 ppm, and most preferably 50 to 500 ppm. The DMC catalyst can be added in solid form or as a suspension in a suspension medium which comprises no H-functional groups and/or an H-functional starter compound. The addition of the suspension medium and/or the H-functional starter compound may precede, coincide with or follow the addition of the DMC catalyst. During step (α), an inert gas (for example, nitrogen or a noble gas such as argon), an inert gas/carbon dioxide mixture, or carbon dioxide can be passed through the reactor at a temperature of 50 to 200° C., preferably of 80 to 160° C., more preferably of 125 to 135° C., and at the same time a reduced pressure (absolute) of 10 mbar to 800 mbar, preferably of 40 mbar to 200 mbar, can be set in the reactor by removal of the inert gas or carbon dioxide (with a pump, for example).

The suspension media which are used in step (α) for suspending the DMC catalyst contain no H-functional groups. Suitable suspension media are all polar-aprotic, weakly polar-aprotic and nonpolar-aprotic solvents, none of which contain any H-functional groups. As suspension medium it is also possible to use a mixture of two or more of these suspension media. The following polar-aprotic solvents are mentioned here by way of example: 4-methyl-2-oxo-1,3-dioxolane (also referred to below as cyclic propylene carbonate), 1,3-dioxolan-2-one, acetone, methyl ethyl ketone, acetonitrile, nitromethane, dimethyl sulfoxide, sulfolane, dimethylformamide, dimethylacetamide and N-methylpyrrolidone. The group of the nonpolar- and weakly polar-aprotic solvents includes, for example, ethers, for example dioxane, diethyl ether, methyl tert-butyl ether and tetrahydrofuran, esters, for example ethyl acetate and butyl acetate, hydrocarbons, for example pentane, n-hexane, benzene and alkylated benzene derivatives (e.g. toluene, xylene, ethylbenzene) and chlorinated hydrocarbons, for example chloroform, chlorobenzene, dichlorobenzene and carbon tetrachloride. Preferred suspension media are 4-methyl-2-oxo-1,3-dioxolane, 1,3-dioxolan-2-one, toluene, xylene, ethylbenzene, chlorobenzene and dichlorobenzene, and mixtures of two or more of these suspension media; particular preference is given to 4-methyl-2-oxo-1,3-dioxolane and 1,3-dioxolan-2-one or a mixture of 4-methyl-2-oxo-1,3-dioxolane and 1,3-dioxolan-2-one.

In an alternative embodiment, one or more compounds selected from the group consisting of aliphatic lactones, aromatic lactones, lactides, cyclic carbonates having at least three optionally substituted methylene groups between the oxygen atoms of the carbonate group, aliphatic cyclic anhydrides and aromatic cyclic anhydrides are as suspension media employed in step (α) for suspending the DMC catalyst. Without being tied to a theory, suspension media of this kind are incorporated into the polymer chain in the subsequent course of the ongoing polymerization in the presence of a starter compound. As a result, there is no need for downstream purification steps.

Aliphatic or aromatic lactones are cyclic compounds containing an ester bond in the ring. Preferred compounds are 4-membered-ring lactones such as β-propiolactone, β-butyrolactone, β-isovalerolactone, β-caprolactone, β-isocaprolactone, β-methyl-β-valerolactone, 5-membered-ring lactones, such as γ-butyrolactone, γ-valerolactone, 5-methylfuran-2(3H)-one, 5-methylidenedihydrofuran-2(3H)-one, 5-hydroxyfuran-2(5H)-one, 2-benzofuran-1(3H)-one and 6-methyl-2-benzofuran-1(3H)-one, 6-membered-ring lactones, such as δ-valerolactone, 1,4-dioxan-2-one, dihydrocoumarin, 1H-isochromen-1-one, 8H-pyrano[3,4-b]pyridin-8-one, 1,4-dihydro-3H-isochromen-3-one, 7,8-dihydro-5H-pyrano[4,3-b]pyridin-5-one, 4-methyl-3,4-dihydro-1H-pyrano[3,4-b]pyridin-1-one, 6-hydroxy-3,4-dihydro-1H-isochromen-1-one, 7-hydroxy-3,4-dihydro-2H-chromen-2-one, 3-ethyl-1H-isochromen-1-one, 3-(hydroxymethyl)-1H-isochromen-1-one, 9-hydroxy-1H,3H-benzo[de]isochromen-1-one, 6,7-dimethoxy-1,4-dihydro-3H-isochromen-3-one and 3-phenyl-3,4-dihydro-1H-isochromen-1-one, 7-membered-ring lactones, such as ε-caprolactone, 1,5-dioxepan-2-one, 5-methyloxepan-2-one, oxepane-2,7-dione, thiepan-2-one, 5-chlorooxepan-2-one, (4S)-4-(propan-2-yl)oxepan-2-one, 7-butyloxepan-2-one, 5-(4-aminobutyl)oxepan-2-one, 5-phenyloxepan-2-one, 7-hexyloxepan-2-one, (5S,7S)-5-methyl-7-(propan-2-yl)oxepan-2-one, 4-methyl-7-(propan-2-yl)oxepan-2-one, and lactones with higher numbers of ring members, such as (7E)-oxacycloheptadec-7-en-2-one.

Lactides are cyclic compounds containing two or more ester bonds in the ring. Preferred compounds are glycolide (1,4-dioxane-2,5-dione), L-lactide (L-3,6-dimethyl-1,4-dioxane-2,5-dione), D-lactide, DL-lactide, mesolactide and 3-methyl-1,4-dioxane-2,5-dione, 3-hexyl-6-methyl-1,4-dioxane-2,5-diones, 3,6-di(but-3-en-1-yl)-1,4-dioxane-2,5-dione (in each case inclusive of optically active forms). Particular preference is given to L-lactide.

Cyclic carbonates used are preferably compounds having at least three optionally substituted methylene groups between the oxygen atoms of the carbonate group. Preferred compounds are trimethylene carbonate, neopentyl glycol carbonate (5,5-dimethyl-1,3-dioxan-2-one), 2,2,4-trimethyl-1,3-pentanediol carbonate, 2,2-dimethyl-1,3-butanediol carbonate, 1,3-butanediol carbonate, 2-methyl-1,3-propanediol carbonate, 2,4-pentanediol carbonate, 2-methylbutane-1,3-diol carbonate, TMP monoallyl ether carbonate, pentaerythritol diallyl ether carbonate, 5-(2-hydroxyethyl)-1,3-dioxan-2-one, 5-[2-(benzyloxy)ethyl]-1,3-dioxan-2-one, 4-ethyl-1,3-dioxolan-2-one, 1,3-dioxolan-2-one, 5-ethyl-5-methyl-1,3-dioxan-2-one, 5,5-diethyl-1,3-dioxan-2-one, 5-methyl-5-propyl-1,3-dioxan-2-one, 5-(phenylamino)-1,3-dioxan-2-one and 5,5-dipropyl-1,3-dioxan-2-one. Particular preference is given to trimethylene carbonate and neopentyl glycol carbonate.

Under the conditions of the process of the invention for preparation of branched polyethercarbonate polyols, cyclic carbonates having fewer than three optionally substituted methylene groups between the oxygen atoms of the carbonate group are incorporated into the polymer chain not at all or only to a small extent.

However, cyclic carbonates having fewer than three optionally substituted methylene groups between the oxygen atoms of the carbonate group may be used together with other suspension media. Preferred cyclic carbonates having fewer than three optionally substituted methylene groups between the oxygen atoms of the carbonate group are ethylene carbonate, propylene carbonate, 2,3-butanediol carbonate, 2,3-pentanediol carbonate, 2-methyl-1,2-propanediol carbonate and 2,3-dimethyl-2,3-butanediol carbonate.

Cyclic anhydrides used are cyclic compounds containing an anhydride group in the ring. Preferred compounds are succinic anhydride, maleic anhydride, phthalic anhydride, 1,2-cyclohexanedicarboxylic anhydride, diphenic anhydride, tetrahydrophthalic anhydride, methyltetrahydrophthalic anhydride, norbornenedioic anhydride and the chlorination products thereof, succinic anhydride, glutaric anhydride, diglycolic anhydride, 1,8-naphthalic anhydride, succinic anhydride, dodecenylsuccinic anhydride, tetradecenylsuccinic anhydride, hexadecenylsuccinic anhydride, octadecenylsuccinic anhydride, 3- and 4-nitrophthalic anhydride, tetrachlorophthalic anhydride, tetrabromophthalic anhydride, itaconic anhydride, dimethylmaleic anhydride, allylnorbornenedioic anhydride, 3-methylfuran-2,5-dione, 3-methyldihydrofuran-2,5-dione, dihydro-2H-pyran-2,6(3H)-dione, 1,4-dioxane-2,6-dione, 2H-pyran-2,4,6(3H,5H)-trione, 3-ethyldihydrofuran-2,5-dione, 3-methoxydihydrofuran-2,5-dione, 3-(prop-2-en-1-yl)dihydrofuran-2,5-dione, N-(2,5-dioxotetrahydrofuran-3-yl)formamide and 3[(2E)-but-2-en-1-yl]dihydrofuran-2,5-dione. Particular preference is given to succinic anhydride, maleic anhydride and phthalic anhydride.

Step (β):

In a preferred embodiment, the amount of one or more alkylene oxides used in the activation in step (β) is 0.1 to 25.0% by weight, preferably 1.0 to 20.0% by weight, particularly preferably 5 to 16.0% by weight (based on the amount of suspension medium and/or H-functional starter compound used in step (α)). The alkylene oxide can be metered into the reactor continuously over a prolonged period, be added in one step, or be added stepwise in a plurality of portions.

Step (γ):

Preferably, an excess of carbon dioxide is used, based on the calculated amount of carbon dioxide incorporated in the polyethercarbonate polyol, since an excess is advantageous because of the low reactivity of carbon dioxide. The amount of carbon dioxide can be fixed via the total pressure under the respective reaction conditions. An advantageous total pressure (absolute) has proven to be in the range from 0.01 to 120 bar, preferably 0.1 to 110 bar, more preferably from 1 to 100 bar, for the copolymerization for preparing the higher-functionality polyethercarbonate polyols. It is possible to feed in the carbon dioxide continuously or discontinuously. This depends on how quickly the alkylene oxides and the CO₂ are consumed and on whether the product is to include any CO₂-free polyether blocks or blocks with different CO₂ contents. The amount of the carbon dioxide (reported as pressure) can likewise vary in the course of addition of the alkylene oxides. Depending on the reaction conditions selected, it is possible for the CO₂ to be introduced into the reactor in the gaseous, liquid or supercritical state. CO₂ can also be added to the reactor in solid form and then be converted under the selected reaction conditions to the gaseous, dissolved, liquid and/or supercritical state.

The alkylene oxides used in step (γ) may be the same as or different than the alkylene oxides used in step (β). The alkylene oxide can be metered into the reactor over a prolonged period, be added in one step, or be added stepwise in a plurality of portions.

The branching compound can be added dissolved in a solvent or in alkylene oxide, in which case the concentration thereof is 1% to 50% by weight, preferably 2% to 18% by weight, more preferably 5% to 15% by weight. Suitable solvents are the abovementioned polar aprotic, weakly polar aprotic and nonpolar aprotic solvents in which the branching compound is soluble. In an alternative embodiment, the branching compound can be added neat, while the alkylene oxides are metered in separately in parallel.

In a further configuration of the process, the temperature in step (γ) may be ≧90° C. and ≦130° C. This temperature range for the performance of the polymerization reaction has been found to be particularly advantageous for reasons of process economy and the properties of the higher functionality polyethercarbonate polyols thus obtainable. The yields of branched polyethercarbonate polyols achievable within this temperature range are high and a virtually complete conversion of monomers is achieved. At the same time, the branched polyethercarbonate polyols obtainable feature a narrow molecular mass distribution and controllable functionality. In a further embodiment of the invention, the temperature in step (γ) may additionally be ≧95° C. and ≦115° C.

The process of the invention can be conducted continuously, semi-batchwise or batchwise.

The three steps α, β and γ can be performed in the same reactor, or each can be performed separately in different reactors. Particularly preferred reactor types are stirred tanks, tubular reactors and loop reactors. If the reaction steps α, β and γ are performed in different reactors, a different reactor type can be used for each step.

Polyethercarbonate polyols can be prepared in a stirred tank, in which case the stirred tank, according to the design and mode of operation, is cooled via the reactor shell, internal cooling surfaces and/or cooling surfaces within a pumped circulation system. Both in semi-batchwise application, in which the product is not removed until after the end of the reaction, and in continuous application, in which the product is removed continuously, particular attention should be paid to the metering rate of the alkylene oxide. This should be set such that, in spite of the inhibiting action of the carbon dioxide, the alkylene oxides are depleted quickly enough. The concentration of free alkylene oxides in the reaction mixture during the activation step (step (β)) is preferably >0 to 100% by weight, especially preferably >0 to 50% by weight, most preferably >0 to 20% by weight (based in each case on the weight of the reaction mixture). The concentration of free alkylene oxides in the reaction mixture during the copolymerization (steps (γ) and (δ)) is preferably >0 to 40% by weight, especially preferably >0 to 25% by weight, most preferably >0 to 15% by weight (based in each case on the weight of the reaction mixture).

Another possible embodiment of the invention for the copolymerization (step (γ)) is characterized in that one or more H-functional starter compounds are metered continuously into the reactor during the reaction. In the case of performance of the process in semi-batchwise operation, the amount of the H-functional starter compounds which are metered continuously into the reactor during the reaction is preferably at least 20 mol % equivalents, more preferably 70 to 95 mol % equivalents (based in each case on the total amount of H-functional starter compounds). In the case of continuous performance of the process, the amount of the H-functional starter compounds which are metered continuously into the reactor during the reaction is preferably at least 80 mol % equivalents, more preferably 95 to 100 mol % equivalents (based in each case on the total amount of H-functional starter compounds).

In a preferred embodiment, the catalyst-starter mixture activated as per steps (α) and (β) is reacted further with alkylene oxides, branching compound and carbon dioxide in the same reactor.

In a further preferred embodiment, the catalyst-starter mixture activated as per steps (α) and (β) is reacted fluffier with alkylene oxides, branching compound and carbon dioxide in a different reaction vessel (for example a stirred tank, tubular reactor or loop reactor).

In a further preferred embodiment, the catalyst-starter mixture dried in step (α) is reacted in a different reaction vessel (for example, a stirred tank, tubular reactor or loop reactor) in steps (β) and (γ) with alkylene oxides, branching compound and carbon dioxide.

When the reaction is conducted in a tubular reactor, the catalyst-starter mixture dried in step (α) or the catalyst-starter mixture activated in steps (α) and (β) and optionally further starter compound and alkylene oxides, branching compound and carbon dioxide are pumped continuously through a tube. When using a catalyst-starter mixture dried as per step α, the activation as per step (β) takes place in the first part of the tubular reactor, and the copolymerization as per step (β) takes place in the second part of the tubular reactor. The molar ratios of the co-reactants vary according to the desired polymer. In a preferred embodiment, carbon dioxide is metered in here in its liquid or supercritical form, in order to enable optimal miscibility of the components. The carbon dioxide can be introduced in the reactor at the inlet of the reactor and/or via metering points arranged along the reactor. A portion of the alkylene oxide may be introduced at the inlet of the reactor. The remaining amount of the alkylene oxide is preferably introduced into the reactor via a plurality of metering points arranged along the reactor. Advantageously, mixing elements for better mixing of the co-reactants are installed, as sold, for example, by Ehrfeld Mikrotechnik BTS GmbH, or mixer-heat exchanger elements which simultaneously improve the mixing and heat removal. The mixing elements preferably mix metered-in CO₂ and/or alkylene oxide with the reaction mixture. In an alternative embodiment, different volume elements of the reaction mixture are mixed with one another.

Loop reactors can likewise be used for preparation of polyethercarbonate polyols. These generally include reactors having internal and/or external material recycling (optionally with heat exchanger surfaces arranged in the circulation system), for example a jet loop reactor or Venturi loop reactor, which can also be operated continuously, or a tubular reactor designed in the form of a loop with suitable apparatuses for the circulation of the reaction mixture, or a loop of several series-connected tubular reactors or a plurality of series-connected stirred tanks.

In order to achieve full reactant conversion, the reaction apparatus in which step (γ) is carried out may be followed by a further tank or a tube (“delay tube”) in which residual concentrations of free alkylene oxides present after the reaction are depleted. Preferably, the pressure in this downstream reactor is at the same pressure as in the reaction apparatus in which reaction step (γ) is performed. The pressure in the downstream reactor can, however, also be selected at a higher or lower level. In a further preferred embodiment, the carbon dioxide, after reaction step (γ), is fully or partly released and the downstream reactor is operated at standard pressure or a slightly elevated pressure. The temperature in the downstream reactor may preferably be 10° C. to 150° C. and preferably 20° C. to 100° C. At the end of the downstream reactor, the reaction mixture contains preferably less than 0.05% by weight of alkylene oxide.

Furthermore, in an additional aspect of the process of the invention, the addition of the branching compound in step (γ) can be effected during any periods of alkylene oxide addition. Preferably, the addition is effected over ≧20% of, preferably ≧50% of, more preferably over ≧80% of and most preferably over the entire period of alkylene oxide addition. Without being bound by the theory, the gradual addition of the branching compound prevents inhibition of the DMC catalyst.

In a preferred embodiment of the process of the invention, the molar ratio of the addition rate of the alkylene oxide to the addition rate of the branching compound at any time in the process of the invention is ≧2.5. More preferably, this ratio is in the range of ≧2.5 and ≦200, most preferably in the range of ≧5.0 and ≦100. Without being bound to a theory, the catalyst used is deactivated when the ratio goes lower.

In a further embodiment of the process of the invention, the addition of the branching compound is complete before 50 mol % of the total amount of the alkylene oxide in this reaction has been added.

In a further embodiment of the process of the invention, the addition of the branching compound is commenced after 50 mol % of the total amount of the alkylene oxide in this reaction has been added.

Without being bound by a filmy, different molecular geometries of the higher-functionality polyethercarbonate polyol may result as a function of the juncture of addition of the branching compound. One way in which the juncture of addition can affect the molecular geometry obtainable is shown in the following scheme (here by way of example: addition of two equivalents of the branching compound per equivalent of bifunctional starter compound; the polymer chain is shown as a line):

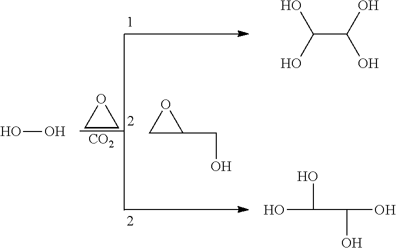

Reaction Version 1: The “Early Addition”:

The addition of the branching compound is preferably complete before more than half, more preferably before more than one quarter, of the alkylene oxides have been added (“early addition”). This procedure leads to more of a star-shaped molecular geometry with polymer chains of roughly equal length between the branching molecules incorporated and the terminal OH groups, and to exposed functional groups, for example OH groups, in the outer regions of the polymer structure.

As a consequence, this leads to particularly low viscosity in the resulting polyethercarbonate polyols and to lower gel points on subsequent reaction with crosslinking reagents, such as isocyanates, for example.

Reaction Version 2: The “Late Addition”:

The branching compound can also be added after more than half, optionally after more than three quarters, of the alkylene oxides have been added (“late addition”). Within this embodiment, more elongated molecular geometries are obtained with elevated viscosity and at least partial steric shielding of individual H-functional groups. In the course of a subsequent reaction with crosslinking reagents, for example isocyanates, this can lead to later gel points.

In an alternative embodiment, the branching compound can be added during any periods or during the whole period of alkylene oxide addition. In the case of addition of two or more equivalents of branching compound based on the amount of one starter compound used and continuous addition of the branching compound over a prolonged period of alkylene oxide addition, it is possible for egg-shaped polyethercarbonate molecules having many branching sites to be obtained.

In a further embodiment, at least step (γ) is conducted continuously. More particularly, it is possible that step (γ) comprises a continuous metered addition of the H-functional starter compound. The amount of the H-functional starter compounds metered into the reactor continuously in step (γ) is preferably at least 20 mol % equivalents, more preferably at least 70 mol % equivalents and most preferably at least 95 mol % equivalents (based in each case on the total amount of H-functional starter compounds). Further preferably, alkylene oxide and carbon dioxide are fed continuously to the reactor. A portion of the product mixture is withdrawn continuously from the reactor, such that the amount of product mixture present in the reactor remains constant within certain limits.

It is also possible that step (γ) comprises a discontinuous metered addition of the H-functional starter compound. The discontinuous metered addition of an H-functional starter compound may comprise the addition of the H-functional starter compound in one or more pulses or with constant or varying addition rate over a portion of the period during which, in step (γ), one or more alkylene oxides and carbon dioxide are metered continuously into the resulting mixture. The amount of the further H-functional starter compounds metered into the reactor continuously in step (γ) is preferably at least 20 mol % equivalents, more preferably at least 70 mol % equivalents and most preferably at least 95 mol % equivalents (based in each case on the total amount of H-functional starter compounds). Furthermore, over the reaction time needed to produce the desired molecular weight, the reactor is supplied continuously with alkylene oxide and carbon dioxide.

In one embodiment of the process of the invention for the preparation of higher-functionality polyethercarbonate polyols from one or more alkylene oxides, one or more branching compounds, one or more H-functional starter compounds, and carbon dioxide, in the presence of a double metal cyanide catalyst, the process regime selected may be as follows:
(α1) Under inert gas atmosphere (for example, argon or nitrogen), under an atmosphere of an inert gas-carbon dioxide mixture, or under a pure carbon dioxide atmosphere, at temperatures of 90 to 150° C., preferably of 125 to 135° C., the DMC catalyst is introduced and then the H-functional starter compound is added,
(β1) alkylene oxide is added to the mixture from step (α1) under inert gas or an inert gas-carbon dioxide mixture (for example argon-carbon dioxide mixture or nitrogen-carbon dioxide mixture) or under a pure carbon dioxide atmosphere, at temperatures of 90 to 150° C., preferably of 125 to 135° C., and then
(γ1) branching compound, optionally dissolved in a solvent or in one or more alkylene oxides, and carbon dioxide are metered continuously into the mixture resulting from step (γ1) (“addition of branching compound”),
(δ1) one or more alkylene oxides and carbon dioxide are metered continuously into the mixture resulting from step (γ1) (“copolymerization”).

Steps (γ1) and (δ1) can be conducted in this sequence (“early addition”) and in the reverse sequence (“late addition”). Preference is given to the addition of the branching compound after the activation phase and at the start of the actual polymerization (“early addition”). Steps (γ1) and (δ1) can also be performed repeatedly in any sequence.

The breadth of the molar mass distribution (polydispersity) of the higher-functionality polyethercarbonate polyols obtainable in accordance with the invention may be lower in the case of early addition of the branching compound than in the case of later addition. Thus, the polydispersity in the case of early addition may be below 4.0, and in the case of late addition below 6.0. Preference is given to higher-functionality polyethercarbonate polyols having a polydispersity below 2.5.

The viscosity of the higher-functionality polyethercarbonate polyols of the invention may be lower in the case of early addition of the branching compound than in the case of later addition.

Within a further embodiment of the process of the invention, steps (γ1) and (δ1) can be effected in reverse sequence. This process regime may be advantageous in particular if the desire is for higher-functionality polyethercarbonate polyols that are of relatively high viscosity and have a broad molar mass distribution, i.e., high polydispersity. In addition, this process can advantageously be employed if longer curing times are desirable in the course of further conversions. These longer curing times may, for example, be the result of the molecular geometry through increased shielding of the functional groups at the ends of the polymers.

In a specific embodiment of the process of the invention for preparation of higher-functionality polyethercarbonate polyols from one or more alkylene oxides, one or more branching compounds, one or more H-functional starter compounds, and carbon dioxide, in the presence of a double metal cyanide catalyst, the process regime selected may be as follows:
(α2) Under inert gas atmosphere (for example, argon or nitrogen), under an atmosphere of an inert gas-carbon dioxide mixture, or under a pure carbon dioxide atmosphere, at temperatures of 90 to 150° C., preferably of 125 to 135° C., the DMC catalyst is introduced and then the suspension medium containing no H-functional groups or the H-functional starter compound is added,
(β2) alkylene oxide is added to the mixture from step (α2) under inert gas or an inert gas-carbon dioxide mixture (for example argon-carbon dioxide mixture or nitrogen-carbon dioxide mixture) or under a pure carbon dioxide atmosphere, at temperatures of 90 to 150° C., preferably of 125 to 135° C., and then
(δ21) the H-functional starter compound, a portion of the one or more alkylene oxides and carbon dioxide are metered continuously into the mixture resulting from step (β2) (“copolymerization”),
(γ2) branching compound, optionally dissolved in a solvent or in one or more alkylene oxides, and carbon dioxide are metered continuously into the mixture resulting from step (δ21) (“addition of branching compound”),

(δ22) one or more alkylene oxides and carbon dioxide are metered continuously into the mixture resulting from step (γ) (“copolymerization”).

The ratio of the amount of alkylene oxide in steps (δ21) and (δ22), in this embodiment, determines the architecture of the higher-functionality polyethercarbonate polyols obtained. The amount of alkylene oxide in step (δ21) may be small in relation to the amount of alkylene oxide in step (δ22) (“early addition”). The amount of alkylene oxide in step (δ21) may, however, also be large in relation to the amount of alkylene oxide in step (δ22) (“late addition”). Preferably, the amount of. alkylene oxide in step (δ21) is small in relation to the amount of alkylene oxide in step (δ22) (“early addition”). For example, the ratio of the amount of alkylene oxide in step (δ21) to the amount of alkylene oxide in step (δ22) may be less than 0.5, preferably less than 0.2. Steps (δ21), (γ2) and (δ22) can also be performed repeatedly in any sequence. In a specific embodiment, steps (δ21) and (γ2) are effected in parallel (simultaneously) with one another.

In a further specific embodiment of the process of the invention for preparation of higher-functionality polyethercarbonate polyols from one or more alkylene oxides, one or more branching compounds, one or more H-functional starter compounds, and carbon dioxide, in the presence of a double metal cyanide catalyst, the process regime selected may be as follows:
(α3) Under inert gas atmosphere (for example, argon or nitrogen), under an atmosphere of an inert gas-carbon dioxide mixture, or under a pure carbon dioxide atmosphere, at temperatures of 90 to 150° C., preferably of 125 to 135° C., the DMC catalyst is introduced and then the suspension medium containing no H-functional groups is added,
(β3) alkylene oxide is added to the mixture from step (α3) under inert gas or an inert gas-carbon dioxide mixture (for example argon-carbon dioxide mixture or nitrogen-carbon dioxide mixture) or under a pure carbon dioxide atmosphere, at temperatures of 90 to 50° C., preferably of 125 to 135° C., and then
(γ3) branching compound, optionally dissolved in a solvent or in one or more alkylene oxides, is metered continuously into the mixture resulting from step (β3) (“addition of branching compound”),
(δ3) the H-functional starter compound, one or more alkylene oxides and carbon dioxide are metered continuously into the mixture resulting from step (β3) (“copolymerization”).

The addition of the compounds in steps (γ3) and (δ3) can be commenced in any sequence. Preferably, the addition of the H-functional starter compound, one or more alkylene oxides and carbon dioxide in step (δ3) is commenced before the addition of the branching compound in step (γ3) is commenced. The continuous metering of the branching compound in step (γ3) and of the H-functional starter compound, one or more alkylene oxides, and carbon dioxide in step (δ3), in the case of a continuous process regime, is preferably effected in parallel (simultaneously). However, steps (γ3) and (δ3) can also be conducted alternately or each with repeated pulsed addition of the components. In parallel to the continuous addition of the compounds in steps (γ3) and (δ3), in the case of a continuous process regime, a portion of the product mixture is withdrawn continuously from the reactor. Optionally, the reactor has a further downstream reactor in which the higher-functionality polyethercarbonate polyol obtained is reacted with further alkylene oxide, which contains one epoxy group per molecule in each case, and carbon dioxide (“early addition” of the branching compound). Alternatively, step (δ3) can also be conducted in a first reactor and step (γ3) in a second reactor (“late addition”).

In a preferred embodiment of the process of the invention, the alkylene oxide used is ethylene oxide and/or propylene oxide.

In a further preferred embodiment, the starter compound used comprises polyether polyols and/or oligomerized fatty acids (preferably in hydrogenated form).

In a further embodiment of the process of the invention, the catalyst is a DMC catalyst. The double metal cyanide compounds present DMC catalysts usable with preference in the process of the invention are the reaction products of water-soluble metal salts and water-soluble metal cyanide salts.

Double metal cyanide (DMC) catalysts are known from the prior art for the homopolymerization of alkylene oxides (see, for example. U.S. Pat. No. 3,404,109, U.S. Pat. No. 3,829,505, U.S. Pat. No. 3,941,849, and U.S. Pat. No. 5,158,922). DMC catalysts, which are described in, for example, U.S. Pat. No. 5,470,813, EP-A 700 949, EP-A 743 093, EP-A 761 708, WO97/40086 A1, WO 98/16310 A1, and WO 00/47649 A1, possess a very high activity and allow the preparation of polyethercarbonate polyols at very low catalyst concentrations. A typical example is that of the highly active DMC catalysts which are described in EP-A 700 949 and contain, as well as a double metal cyanide compound (e.g. zinc hexacyanocobaltate(III)) and an organic complex ligand (e.g. tert-butanol), also a polyether having a number-average molecular weight greater than 500 g/mol.

The DMC catalysts which can be used in accordance with the invention are preferably obtained by:

(a) reacting in the first step an aqueous solution of a metal salt with the aqueous solution of a metal cyanide salt in the presence of one or more organic complex ligands, e.g. of an ether or alcohol,

(b) with removal in the second step of the solid from the suspension obtained from (a), by means of known techniques (such as centrifugation or filtration),

(c) with optional washing in a third step of the isolated solid with an aqueous solution of an organic complex ligand (for example by resuspending and subsequently reisolating by filtration or centrifugation),

(d) with subsequent drying of the solid obtained, optionally after pulverization, at temperatures of generally 20-120° C. and at pressures of generally 0.1 mbar to standard pressure (1013 mbar),

wherein in the first step or immediately after the precipitation of the double metal cyanide compound (second step) one or more organic complex ligands, preferably in excess (based on the double metal cyanide compound), and optionally further complex-forming components are added.

For example, an aqueous zinc chloride solution (preferably in excess relative to the metal cyanide salt) and potassium hexacyanocobaltate are mixed and then dimethoxyethane (glyme) or tert-butanol (preferably in excess, relative to zinc hexacyanocobaltate) is added to the resulting suspension.

Metal salts suitable for preparation of the double metal cyanide compounds preferably have a composition of the following general formula:

M(X)ₙ

where M is selected from the metal cations Zn²⁺, Fe²⁺, Ni²⁺, Mn²⁺, Co²⁺, Sr²⁺, Pb²⁺ and Cu²⁺.

Preferably, M is Zn²⁺, Fe²⁺, Co²⁺ or Ni²⁺, X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate; n is 1 when X=sulfate, carbonate or oxalate, and n is 2 when X=halide, hydroxide, carboxylate, cyanate, thiocyanate, isocyanate, isothiocyanate or nitrate.

Likewise suitable metal salts have a composition according to the following general formula:

Mᵣ(X)₃

where M is selected from the metal cations Fe³⁺, Al³⁺, Co³⁺ and Cr³⁺, X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate; r is 2 when X=sulfate, carbonate or oxalate, and r is 1 when X=halide, hydroxide, carboxylate, cyanate, thiocyanate, isocyanate, isothiocyanate or nitrate.

Likewise suitable metal salts have a composition according to the following general formula:

M(X)ₛ

where M is selected from the metal cations Mo⁴⁺, V⁴⁺ and W⁴⁺, X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate; s is 2 when X=sulfate, carbonate or oxalate, and s is 4 when X=halide, hydroxide, carboxylate, cyanate, thiocyanate, isocyanate, isothiocyanate or nitrate.

Likewise suitable metal salts have a composition according to the following general formula:

M(X)ₜ

where M is selected from the metal cations Mo⁶⁺ and W⁶⁺, X is one or more (i.e. different) anions, preferably an anion selected from the group of the halides (i.e. fluoride, chloride, bromide, iodide), hydroxide, sulfate, carbonate, cyanate, thiocyanate, isocyanate, isothiocyanate, carboxylate, oxalate and nitrate; t is 3 when X=sulfate, carbonate or oxalate, and t is 6 when X=halide, hydroxide, carboxylate, cyanate, thiocyanate, isocyanate, isothiocyanate or nitrate.

Examples of suitable metal salts are zinc chloride, zinc bromide, zinc iodide, zinc acetate, zinc acetylacetonate, zinc benzoate, zinc nitrate, iron(II) sulfate, iron(II) bromide, iron(II) chloride, iron(III) chloride, cobalt(II) chloride, cobalt(II) thiocyanate, nickel(II) chloride and nickel(II) nitrate. It is also possible to use mixtures of different metal salts.

Metal cyanide salts suitable for preparation of the double metal cyanide compounds preferably have a composition of the following general formula:

(Y)ₐM′(CN)_{b}(A)_{c}

where M′ is selected from one or more metal cations of the group consisting of Fe(II), Fe(III), Co(II), Co(III), Cr(II), Cr(III), Mn(II), Mn(III), Ir(III), Ni(II), Rh(III), Ru(II), V(IV) and V(V). M′ preferably being one or more metal cations of the group consisting of Co(I), Co(III), Fe(II), Fe(III), Cr(III), Ir(III) and Ni(II), Y is selected from one or more metal cations of the group consisting of alkali metal (i.e., Li⁺, Na⁺, K⁺, Rb⁺) and alkaline earth metal (i.e., Be²⁺, Mg²⁺, Ca²⁺, Sr²⁺, Ba²⁺), A is selected from one or more anions of the group consisting of halides (i.e., fluoride, chloride, bromide, iodide), hydroxide, sulfate, carbonate, cyanate, thiocyanate, isocyanate, isothiocyanate, carboxylate, azide, oxalate or nitrate, and a, b and c are integers, where the values of a, b and c are chosen so as to ensure electronic neutrality of the metal cyanide salt; a is preferably 1, 2, 3 or 4; b is preferably 4, 5 or 6; c preferably has a value of 0.

Examples of suitable metal cyanide salts are sodium hexacyanocobaltate(III), potassium hexacyanocobaltate(III), potassium hexacyanoferrate(II), potassium hexacyanoferrate(III), calcium hexacyanocobaltate(III) and lithium hexacyanocobaltate(III).

Preferred double metal cyanide compounds which are present in the DMC catalysts useful in accordance with the invention are compounds having a composition according to the following general formula:

Mₓ[M′_{x′}(CN)_{y}]ₓ

in which M and M′ are each as defined above and x, x′, y and z are integers and are chosen so as to ensure electronic neutrality of the double metal cyanide compound.

Preferably, x=3, x′=1, y=6 and z=2, M=Zn(II), Fe(II), Co(II) or Ni(II) and M′=Co(III), Fe(III), Cr(III) or Ir(III).

Examples of suitable double metal cyanide compounds a) are zinc hexacyanocobaltate(III), zinc hexacyanoiridate(III), zinc hexacyanoferrate(III) and cobalt(II) hexacyanocobaltate(III). Further examples of suitable double metal cyanide compounds can be found, for example, in U.S. Pat. No. 5,158,922 (column 8, lines 29-66). Particular preference is given to using zinc hexacyanocobaltate(III).

The organic complex ligands added in the preparation of the DMC catalysts are disclosed, for example, in U.S. Pat. No. 5,158,922 (see especially column 6 lines 9 to 65), U.S. Pat. No. 3,404,109, U.S. Pat. No. 3,829,505, U.S. Pat. No. 3,941,849, EP-A 700 949, EP-A 761 708, JP 4 145 123, U.S. Pat. No. 5,470,813, EP-A 743 093 and WO-A 97/40086). The organic complex ligands used are, for example, water-soluble organic compounds containing heteroatoms such as oxygen, nitrogen, phosphorus or sulfur, which can form complexes with the double metal cyanide compound. Preferred organic complex ligands are alcohols, aldehydes, ketones, ethers, esters, amides, ureas, nitriles, sulfides and mixtures thereof. Particularly preferred organic complex ligands are aliphatic ethers (such as dimethoxyethane), water-soluble aliphatic alcohols (such as ethanol, isopropanol, n-butanol, isobutanol, sec-butanol, tert-butanol, 2-methyl-3-buten-2-ol and 2-methyl-3-butyn-2-ol), compounds containing both aliphatic or cycloaliphatic ether groups and aliphatic hydroxyl groups (for example ethylene glycol mono-tert-butyl ether, diethylene glycol mono-tert-butyl ether, tripropylene glycol monomethyl ether and 3-methyl-3-oxetanemethanol). Extremely preferred organic complex ligands are selected from one or more compounds of the group consisting of dimethoxyethane, tert-butanol 2-methyl-3-buten-2-ol, 2-methyl-3-butyn-2-ol, ethylene glycol mono-tert-butyl ether, and 3-methyl-3-oxetanemethanol.

Optionally in the preparation of the DMC catalysts that can be used in accordance with the invention, use is made of one or more complex-forming components from the classes of compound of the polyethers, polyesters, polycarbonates, polyalkylene glycol sorbitan esters, polyalkylene glycol glycidyl ethers, polyacrylamide, poly(acrylamide-co-acrylic acid), polyacrylic acid, poly(acrylic acid-co-maleic acid), polyacrylonitrile, polyalkyl acrylates, polyalkyl methacrylates, polyvinyl methyl ether, polyvinyl ethyl ether, polyvinyl acetate, polyvinyl alcohol, poly-N-vinylpyrrolidone, poly(N-vinylpyrrolidone-co-acrylic acid), polyvinyl methyl ketone, poly(4-vinylphenol), poly(acrylic acid-co-styrene), oxazoline polymers, polyalkylenimines, maleic acid copolymers and maleic anhydride copolymers, hydroxyethylcellulose, and polyacetals, or the glycidyl ethers, glycosides, carboxylic esters of polyhydric alcohols, gallic acids or the salts, esters, or amides thereof, cyclodextrins, phosphorus compounds, α,β-unsaturated carboxylic esters, or ionic surface-active or interface-active compounds.

In the preparation of the DMC catalysts that can be used in accordance with the invention, preference is given to using the aqueous solutions of the metal salt (e.g. zinc chloride) in the first step in a stoichiometric excess (at least 50 mol %) relative to the metal cyanide salt. This corresponds at least to a molar ratio of metal salt to metal cyanide salt of 2.25:1.00. The metal cyanide salt (e.g. potassium hexacyanocobaltate) is reacted in the presence of the organic complex ligand (e.g. tert-butanol), and a suspension is formed which comprises the double metal cyanide compound (e.g. zinc hexacyanocobaltate), water, excess metal salt, and the organic complex ligand.

This organic complex ligand may be present in the aqueous solution of the metal salt and/or of the metal cyanide salt, or it is added directly to the suspension obtained after precipitation of the double metal cyanide compound. It has proven advantageous to mix the metal salt and metal cyanide salt aqueous solutions and the organic complex ligand by stirring vigorously. Optionally, the suspension formed in the first step is subsequently treated with a further complex-forming component. The complex-forming component is preferably used in a mixture with water and organic complex ligand. A preferred process for performing the first step (i,e. the preparation of the suspension) is effected using a mixing nozzle, more preferably using a jet disperser, as described, for example, in WO-A 01/39883.

In the second step, the solid (i.e. the precursor of the inventive catalyst) is isolated from the suspension by known techniques, such as centrifugation or filtration.

In a preferred execution variant, the isolated solid is subsequently washed in a third process step with an aqueous solution of the organic complex ligand (for example by resuspension and subsequent reisolation by filtration or centrifugation). In this way, it is possible to remove, for example, water-soluble by-products such as potassium chloride from the inventive catalyst. Preferably, the amount of the organic complex ligand in the aqueous wash solution is between 40% and 80% by weight, based on the overall solution.

Optionally in the third step the aqueous wash solution is admixed with a further complex-forming component, preferably in the range between 0.5% and 5% by weight, based on the overall solution.

It is moreover advantageous to wash the isolated solid more than once. Washing takes place preferably, in a first washing step (c-1), with an aqueous solution of the unsaturated alcohol (by means, for example, of resuspension and subsequent reisolation by filtration or centrifugation), in order thereby to remove for example water-soluble by-products, such as potassium chloride, from the catalyst of the invention. Especially preferably, the amount of the unsaturated alcohol in the aqueous wash solution is between 40 and 80% by weight, based on the overall solution in the first washing step. In the further washing steps (c-2) either the first washing step is repeated once or several times, preferably from one to three times, or, preferably, a nonaqueous solution, such as a mixture or solution of unsaturated alcohol and further complex-forming component (preferably in the range between 0.5% and 5% by weight, based on the total amount of the wash solution of step (c-2)), is used as the wash solution, and the solid is washed with it once or more than once, preferably from one to three times.

The isolated and optionally washed solid is then dried, optionally after pulverization, at temperatures of 20-100° C. and at pressures of 0.1 mbar to atmospheric pressure (1013 mbar).

One particularly preferred method for isolating the DMC catalysts of the invention from the suspension, by filtration, filtercake washing, and drying, is described in WO-A 01/80994, for example.

In a further embodiment of the process of the invention, the branching compound is selected from the group of the glycidyl alcohols, the oxetane alcohols, the monoglycidyl ethers of diols, the mono- or diglycidyl ethers of triols, the unsubstituted or substituted 3-hydroxyalkyloxetanes and/or the compounds of the following formula:

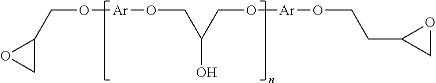

where Ar may be a divalent aromatic, araliphatic, cycloaliphatic or aliphatic radical which has 5 to 22 carbon atoms and may also contain heteroatoms such as oxygen or sulfur and n is a natural number from 1 to 10.

As a result of the additional OH groups, the compounds mentioned lead to an additional increase in the average functionality of the polyols in the reaction mixture.

With regard to the glycidyl alcohols, preference is given to glycidol(2,3-epoxy-1-propanol).

With regard to the oxetane alcohols, preference is given to 3-methyl-3-oxetanemethanol and ethylhydroxymethyloxetane.

Examples of suitable monoglycidyl ethers are monoglycidyl ethers of ethylene glycol, 1,2-propylene glycol, 1,3-propylene glycol, neopentyl glycol, butane-1,4-diol, adipol, diethylene glycol, triethylene glycol, dipropylene glycol, tripropylene glycol, oligoethylene or -propylene glycols having a molar mass of 300 to 1000 g/mol, octanediol, decanediol, dodecanediol, dimeric fatty diol, 2-methylpropane-1,3-diol, cyclohexanedimethanol, TCD diol, pinanediol, hydroquinone, resorcinol, bisphenol F, bisphenol A or ring-hydrogenated bisphenol A.

Preferred mono- or diglycidyl ethers of triols are mono- or diglycidyl ethers of glycerol. These may also be used in the form of a technical grade mixture as represented, for example, by the following formula:

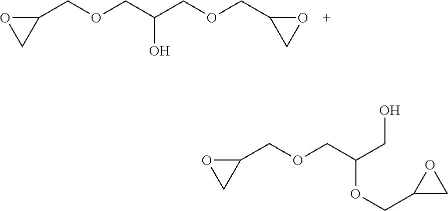 [SMILES: OC(COCC1CO1)COCC1CO1 ; OCC(COCC1CO1)OCC1CO1]

Technical grade glycidyl ethers may also contain products of additive oligomerization, wherein the monomer units are joined via the —O—CH₂—CH(OH)—CH₂—O— fragment. These products too form part of the invention.

In a further embodiment of the process of the invention, the polyethercarbonate polyol obtained is reacted with di- and/or polyisocyanates in an additional subsequent process step. Examples of suitable isocyanates are butylene 1,4-diisocyanate, pentane 1,5-diisocyanate, hexamethylene 1,6-diisocyanate (HDI), isophorone diisocyanate (IPDI), 2,2,4- and/or 2,4,4-trimethylhexamethylene diisocyanate, the isomeric bis(4,4′-isocyanatocyclohexyl)methanes or mixtures thereof with any desired isomer content, cyclohexylene 1,4-diisocyanate, phenylene 1,4-diisocyanate, tolylene 2,4- and/or 2,6-diisocyanate (TDI), naphthylene 1,5-diisocyanate, diphenylmethane 2,2- and/or 2,4′- and/or 4,4′-diisocyanate (MDI) and/or higher homologs (polymeric MDI), 1,3- and/or 1,4-bis(2-isocyanatoprop-2-yl)benzene (TMXDI), 1,3-bis(isocyanatomethyl)benzene (XDI), and also alkyl 2,6-diisocyanatohexanoates (lysine diisocyanates) having C₁ to C₆-alkyl groups.

In addition to the abovementioned polyisocyanates, it is also possible to use proportions of modified diisocyanates of uretdione, isocyanurate, urethane, carbodiimide, uretoneimine, allophanate, biuret, amide, iminooxadiazinedione and/or oxadiazinetrione structure and also unmodified polyisocyanate having more than 2 NCO groups per molecule, for example 4-isocyanatomethyl-1,8-octane diisocyanate (nonane triisocyanate) or triphenylmethane 4,4′,4″-triisocyanate.

The isocyanate may be a prepolymer obtainable by reacting an isocyanate having an NCO functionality of >2 and polyols having a molecular weight of ≧62 g/mol to ≦8000 g/mol and OH functionalities of ≧1.5 to ≦6.

The present invention further provides a polyethercarbonate polyol obtainable by a process of the invention. Advantageously, the molecular weight of the resulting polyethercarbonate polyols may be at least 400 g/mol, preferably 400 to 1 000 000 g/mol, more preferably 500 to 60 000 g/mol and most preferably 2000 to 3000 g/mol. These molecular weight ranges, together with the controllable molecular geometry, can lead to suitable viscosities of the higher-functionality polyethercarbonate polyols.

More particularly, the lower viscosity of the branched polyethercarbonate polyols of the invention compared to linear polyethercarbonate polyols (given the same OH number, molar mass and glass transition temperature) improves the ease of industrial handling. In addition, the branched polyethercarbonates of the invention feature a high reactivity toward crosslinking reagents such as isocyanates, which is manifested by shorter times for attainment of the gel point.

The polyethercarbonate polyols preparable in accordance with the invention can be used in detergent and cleaning product formulations, drilling fluids, fuel additives, ionic and nonionic surfactants, lubricants, process chemicals for papermaking or textiles production, cosmetic formulations, or as pore formers in the manufacture of ceramics. The flexibility of the process of the invention allows controlled preparation of higher-functionality polyethercarbonate polyols having controllable functionalities, molecular weight distributions and viscosities, which can advantageously be used in the abovementioned fields of application. The person skilled in the art is aware that, depending on the respective field of use, the polyethercarbonate polyols to be used have to fulfill certain material properties, for example molecular weight, viscosity, functionality and/or hydroxyl number.

In the case of reaction with difunctional or higher-functionality crosslinking reagents, for example isocyanates, the polyethercarbonates of the invention form networks having elastomeric or thermoset character depending on whether the use temperature is above or below the glass transition temperature. This is a preferred field of use of the branched polyethercarbonates of the invention. The elastomers may have the character of shaped bodies or flat structures (coatings, films).

Therefore, a further aspect of the invention is a crosslinked polyethercarbonate polymer obtainable by the above-described process of reaction of the polyethercarbonate polyols with di- and/or polyisocyanates.

The isocyanate-crosslinked polyethercarbonate polymers obtainable by this process may be notable for a simple process regime in the production thereof and improved mechanical properties. This is probably because of the higher functionality per crosslinkable polyethercarbonate polyol molecule compared to unbranched polyethercarbonate polymers. The controllable viscosity of the higher-functionality polyethercarbonate polyols may be utilized, moreover, for providing higher-functionality polyethercarbonate polyols of extremely low viscosity, which may lead to particularly fast-curing and homogeneous products.

In addition, the crosslinked polyethercarbonate polymers may be used in thermoset shaped bodies, viscoelastic foams or coatings. The higher-functionality polyethercarbonate polyols obtained by the process of the invention can be processed without difficulty, especially by reaction with di- and/or polyisocyanates to give polyurethanes, especially to give flexible polyurethane foams, rigid polyurethane foams, polyurethane elastomers or polyurethane coatings. For polyurethane applications, it is possible with preference to use higher-functionality polyethercarbonate polyols having a functionality of at least 2, preferably at least 2.5 and more preferably at least 2.8. As a function of the glass transition temperature and use temperature of the crosslinked polyethercarbonate polymers, it is possible in this way to produce shaped bodies or layers having elastomeric or thermoset character.

The scope of the invention additionally includes shaped bodies having a layer comprising a crosslinked polyethercarbonate polymer. The layers which can be produced in accordance with the invention may contribute to mechanical and chemical protection on shaped bodies and may contribute accordingly to an increased useful life of workpieces. By virtue of the high functionality and controllable viscosity, these layers on shaped bodies can be produced rapidly and uniformly.

For further advantages and features of the above-described use, reference is hereby made explicitly to the elucidations in connection with the polymers of the invention and with the process of the invention. Inventive features and advantages of the process are also intended to be applicable to the polymers of the invention and the use of the invention, and are considered to be disclosed as such, and vice versa. The invention also encompasses all combinations of at least two features disclosed in the description and/or in the claims.

### EXAMPLES

The present invention is elucidated further by the examples which follow, but without being restricted thereto.

PET-1: Bifunctional polypropylene glycol having an OH number of 257 mg_{KOH}/g

PET-2: Trifunctional polypropylene glycol having an OH number of 400 mg_{KOH}/g

Dimer fatty acid: bifunctional hydrogenated dimer fatty acid laving an acid number of 197 mg/g, CAS 68783-41-5

Alkylene Oxides Used:

Propylene oxide having a density of 0.83 g/mL

Branching Compounds Used:

Glycidol having a density of 1.11 g/mL

Glycerol diglycidyl ether having a density of 1.23 g/mL

3-Ethyl-3-oxetanemethanol having a density of 1.019 g/mL

The DMC catalyst was prepared according to example 6 of WO-A 01/80994,

The copolymerization resulted not only in the cyclic propylene carbonate but also in the polyethercarbonate polyol which firstly contains the following polycarbonate units:

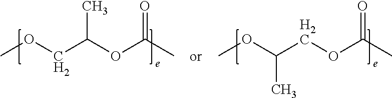

and secondly the following polyether units:

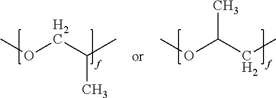

The reaction mixture was characterized by ¹H NMR spectroscopy (determination of the content of unconverted propylene oxide and cyclic carbonate).

Subsequently, the reaction mixture was diluted with dichloromethane (20 mL) and the solution was passed through a falling-film evaporator. The solution (0.1 kg in 3 h) ran downwards along the inner wall of a tube of diameter 70 mm and length 200 mm which had been heated externally to 120° C., in the course of which the reaction mixture was distributed homogeneously as a thin film on the inner wall of the falling-film evaporator in each case by three rollers of diameter 10 mm rotating at a speed of 250 rpm. Within the tube, a pump was used to set a pressure of 3 mbar. The reaction mixture, which had been purified to free it of volatile constituents (unconverted alkylene oxides, cyclic, carbonate, solvent), was collected in a receiver at the lower end of the heated tube. The product mixture obtained was characterized by ¹H NMR spectroscopy (determination of the CO₂ content in the polymer) and gel permeation chromatography, and determination of the OH number, viscosity and gel point.

The weight-average and number-average molecular weights of the resulting polymers were determined by means of gel permeation chromatography (GPC). The procedure of DIN 55672-1 was followed: “Gel permeation chromatography, Part 1—Tetrahydrofuran as eluent” (SECurity GPC System from PSS Polymer Service, flow rate 1.0 mL/min; columns: 2×PSS SDV linear M, 8×300 mm, 5 μm; RID detector). Polystyrene samples of known molar mass were used for calibration. Since the hydrodynamic diameter of the branched polyethercarbonate polyols obtained changes with the degree of branching, there is a divergence in the weight-average and number-average molecular weights of the polymers formed calculated from the amounts used and determined via GPC.

The OH number (hydroxyl number) was determined on the basis of DIN 53240-2, except using N-methylpyrrolidone rather than THF/dichloromethane as the solvent. A 0.5 molar ethanolic KOH solution was used for titration (endpoint recognition by means of potentiometry). The test substance used was castor oil with certified OH number. The reporting of the unit in “mg/g” refers to mg[KOH]/g[polyethercarbonate polyol].

The ratio of the amount of cyclic propylene carbonate to polyethercarbonate polyol (selectivity) and the molar ratio of carbonate groups to ether groups in the polyethercarbonate polyol (e/f ratio) and the proportion of propylene oxide converted (C in mol %) were determined by means of ¹H NMR spectroscopy. Each sample was dissolved in deuterated chloroform and analyzed on a Bruker spectrometer (AV400, 400 MHz). The relevant resonances in the ¹H NMR spectrum (based on TMS=0 ppm) are as follows:

I1: 1.11-1.17: methyl group of the polyether units, resonance area corresponds to three hydrogen atoms

I2: 1.25-1.32: methyl group of the polycarbonate units, resonance area corresponds to three hydrogen atoms

I3: 1.45-1.49: methyl group of the cyclic carbonate, resonance area corresponds to three hydrogen atoms

I4: 2.95-2.99: CH group for free, unreacted of the propylene oxide, resonance area corresponds to one hydrogen atom

I5: 2.38-2.42: CH group for free, unreacted of the glycidol, resonance area corresponds to one hydrogen atom

The figures reported are the ratio of the amount of cyclic propylene carbonate to polymer (selectivity, c/l) and the ratio of carbonate groups to ether groups in the polymer (e/f) and the proportion of the propylene oxide converted (C in mol %).

Taking account of the relative intensities, the values were calculated as follows:

Molar ratio of the amount of cyclic propylene carbonate to polymer (selectivity, c/l):

c/l=I3/I2

Molar ratio of carbonate groups to ether groups in the polymer (e/f):

e/f=I2/I1

The molar proportion of the converted propylene oxide (C in mol %) based on the sum total of the amount of propylene oxide used in the activation and the copolymerization, calculated by the formula:

C=[(((I1/3)+(I2/3))/((I1/3)+(I2/3)+(I3/3)+I4)]*100%

was >99.9% in the examples.

The viscosity of the product mixture was determined using a Physica MCR 501 rheometer from Anton Paar at 30° C., using a sphere/plate, configuration with a sphere diameter of 25 mm and with a distance of 0.05 mm between sphere and plate. The shear rate was increased over 10 minutes from 0.01 to 1000 l/s. A value was taken every 10 seconds. The result reported is the viscosity as the average of the total of 60 measurement values.

For the theological determination of the gel point, the polyethercarbonate polyols were admixed with an equimolar amount of Desmodur N3300 (hexamethylene diisocyanate trimer) and 2000 ppm of dibutyltin laurate (2% in diphenyl ether). The complex moduli G′ (storage modulus) and G″ (loss modulus) were determined in an oscillation Measurement at 40° C. and a frequency of 1 Hz, using a plate/plate configuration with a plate diameter of 15 mm, a plate-to-plate distance of 1 mm, and a 10 percent deformation. The gel point was defined as the time at which G′=G″.

### Example 1

### Preparation of a Branched Polyethercarbonate Polyol of Theoretical Functionality 3.0, Proceeding from a Starter Compound of Functionality 2.0, Using Glycidol as Branching Compound to Increase the Functionality

A 300 mL pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 135.75 g of propylene oxide were metered in by means of an HPLC pump (1 mL/min) while stirring, while continuing to stir the reaction mixture (800 rpm). Fifteen minutes after commencement of the addition of propylene oxide, 2.98 g of glycidol were metered in by means of a separate HPLC pump (0.03 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 31.8.

No accumulation of glycidol in the reaction mixture was obtained.

The NMR spectroscopy analysis of the reaction mixture showed full conversion of the propylene oxide and the glycidol.

The selectivity c/l was 0.08.

The molar ratio of carbonate to ether groups in the polymer e/f was 24.02/75.98.

The weight- and number-average molecular weight of the polyethercarbonate obtained, determined via GPC, was Mₙ=4453 g/mol, M_{w}=6034 g/mol, and the polydispersity was 1.3.

The OH number of the resulting mixture was 35.8 mg_{KOH}/g.

The viscosity of the resulting mixture was 5351 mPa s.

The time until the attainment of the gel point was 15.1 min.

### Example 2

### Preparation of a Branched Polyethercarbonate Polyol of Theoretical Functionality 5.0, Proceeding from a Starter Compound of Functionality 2.0, Using Glycidol as Branching Compound to Increase the Functionality

A 300 mL pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 129.83 g of propylene oxide were metered in by means of an HPLC pump (1.00 mL/min) while stirring, while continuing to stir the reaction mixture (800 rpm). Fifteen minutes after the start of the addition of propylene oxide, 8.9 g of glycidol were metered in by means of a separate HPLC pump (0.09 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 10.6.

No accumulation of glycidol in the reaction mixture was obtained.

The NMR spectroscopy analysis of the reaction mixture showed full conversion of the propylene oxide and the glycidol.

The selectivity 01 was 0.13.

The molar ratio of carbonate groups to ether groups in the polymer e/f was 79.8/20.2.

The weight- and number-average molecular weight of the polyethercarbonate obtained, determined via GPC, was Mₙ=2156 g/mol, M_{w}=3106 g/mol; the polydispersity was 1.4.

The OH number of the resulting mixture was 60.9 mg_{KOH}/g.

The viscosity of the resulting mixture was 3856 mPa s.

The time until the attainment of the gel point was 10.0 min.

### Example 3

### Preparation of a Branched Polyethercarbonate Polyol of Theoretical Functionality 7.0, Proceeding from a Starter Compound of Functionality 2.0, Using Glycidol as Branching Compound to Increase the Functionality

A 300 mL pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 122.5 g of propylene oxide were metered in by means of an HPLC pump (1.00 mL/min) while stirring, while continuing to stir the reaction mixture (800 rpm). Fifteen minutes after the start of the addition of propylene oxide, 14.90 g of glycidol were metered in by means of a separate HPLC pump (0.15 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 6.4.

No accumulation of glycidol in the reaction mixture was obtained.

The NMR spectroscopy analysis of the reaction mixture showed full conversion of the propylene oxide and the glycidol.

The selectivity c/l was 0.14.

The molar ratio of carbonate groups to ether groups in the polymer e/f was 15.8/84.2.

The weight- and number-average molecular weight of the polyethercarbonate obtained, determined via GPC, was Mₙ=1314 g/mol, M_{w}=1996 g/mol; the polydispersity was 1.5.

The OH number of the resulting mixture was 91.7 mg_{KOH}/g.

The viscosity of the resulting mixture was 2167 mPa s.

The time until the attainment of the gel point was 7.5 min.

### Example 4

### Comparative Example

### Preparation of a Linear Polyethercarbonate Having a Functionality of 2

A 300 mL pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 mm [step (α)], CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. After cooling to 100° C., 137.26 g of propylene oxide were metered in by means of an HPLC pump (1 mL/min), while continuing to stir the reaction mixture (800 rpm) [step (δ)]. After the addition of propylene oxide had ended, the reaction mixture was stirred at 100° C. for a further 2 h. The reaction was ended by cooling the reactor in an ice bath, the elevated pressure was released and the resulting product was analyzed.

No glycidol was metered in.

The NMR spectroscopy analysis of the reaction mixture showed full conversion of the propylene oxide.

The selectivity c/l was 0.14.

The molar ratio of carbonate groups to ether groups in the polymer e/f was 18.3/81.7.

The weight- and number-average molecular weight of the polyethercarbonate obtained, determined via GPC, was Mₙ=6631 g/mol, M_{w}=10 609 g/mol; the polydispersity was 1.6.

The OH number of the resulting mixture was 31.8 mg_{KOH}/g.

The viscosity of the resulting mixture was 8159 mPa s.

The time until the attainment of the gel point was 21.6 min.

Comparison of Polyethercarbonate Polyols Prepared by the Process of the Invention with a Linear Polyethercarbonate Diol:

| | Functionality | Viscosity | Gel point |
|---|---|---|---|
| Example | of the product | mPa · s | min |
| 1 | 3 | 5351 | 15.1 |
| 2 | 5 | 3856 | 10.0 |
| 3 | 7 | 2167 | 7.5 |
| 4 (comp.) | 2 | 8159 | 21.6 |

comp.: comparative example

A comparison of examples 1-3 with comparative example 4 shows that the branched polyethercarbonate polyols from examples 1-3, which were prepared using glycidol, have a lower viscosity and a higher reactivity in the case of crosslinking with isocyanates compared to the bifunctional polyethercarbonate diol from example 4. Surprisingly, the viscosity falls with rising content of branching compound (higher functionality), while the reactivity increases.

### Example 5

### Preparation of a Branched Polyethercarbonate Polyol of Theoretical Functionality 2.8, Proceeding from a Starter Compound of Functionality 2.0, Using Glycidol as Branching Compound to Increase the Functionality

A 300 mL pressure reactor equipped with a sparging stirrer was initially charged with a mixture of DMC catalyst (24 mg) and PET-1 (17.4 g), and the mixture was stirred (800 rpm) under a slight vacuum (50 mbar) and a gentle Ar stream at 130° C. for 30 min. [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.65 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 75.83 g of propylene oxide were metered in by means of an HPLC pump (1 mL/mm) while stirring, while continuing to stir the reaction mixture (800 rpm). Fifteen minutes after commencement of the addition of propylene oxide, 2.66 g of glycidol were metered in by means of a separate HPLC pump (0.09 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 10.6.

No accumulation of glycidol in the reaction mixture was obtained.

The NMR spectroscopy analysis of the reaction mixture showed full conversion of the propylene oxide and the glycidol.

The selectivity c/l was 0.07.

The molar ratio of carbonate groups to ether groups in the polymer e/f was 19.3/80.7.

The weight- and number-average molecular weight of the polyethercarbonate obtained, determined via GPC, was Mₙ=2701 g/mol, M_{w}=3517 g/mol; the polydispersity was 1.3.

The OH number of the resulting mixture was 57.3 mg_{KOH}/g.

The viscosity of the resulting mixture was 2330 mPa s.

The time until the attainment of the gel point was 7.1 min.

### Example 6

### Comparative Example

### Preparation of a Polyethercarbonate Having Functionality of 2.8 Proceeding from a Mixture of Starter Compounds of Functionality 2.0 and 3.0

A 300 mL pressure reactor equipped with a sparging stirrer was initially charged with a mixture of DMC catalyst (23 mg), PET-1 (3.48 g) and PET-2 (13.44 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.65 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.65 g of propylene oxide were metered in by means of the HPLC pump (1 mL/min) and the reaction mixture was stirred for 20 min. (800 rpm). The occurrence of a brief increase in evolution of heat in the reactor during this time confirmed the activation of the catalyst [step (β)]. After cooling to 100° C., 91.66 g of propylene oxide were metered in by means of an HPLC pump (1 mL/min), while continuing to stir the reaction mixture (800 rpm) [step (δ)]. After the addition of propylene oxide had ended, the reaction mixture was stirred at 100° C. for a further 2 h. The reaction was ended by cooling the reactor in an ice bath, the elevated pressure was released and the resulting product was analyzed.

No glycidol was metered in.

The NMR spectroscopy analysis of the reaction mixture showed full conversion of the propylene oxide.

The selectivity c/l was 0.11.

The molar ratio of carbonate groups to ether groups in the polymer e/f was 16.7/83.3.

The weight- and number-average molecular weight of the polyethercarbonate obtained, determined via GPC, was Mₙ=3949 g/mol, M_{w}=4720 g/mol; the polydispersity was 1.2.

The OH number of the resulting mixture was 52.0 mg_{KOH}/g.

The viscosity of the resulting mixture was 3911 mPa s.

The time until the attainment of the gel point was 8.2 min.

Comparison of a Polyethercarbonate Polyol Prepared by the Process of the Invention with a Polyethercarbonate Polyol Obtained by Using a Mixture of Starter Compounds of Different Functionality:

| | Functionality | Viscosity | Gel point |
|---|---|---|---|
| Example | of the product | mPa · s | min |
| 5 | 2.8 | 2330 | 7.1 |
| 6 (comp.) | 2.8 | 3911 | 8.2 |

comp.: comparative example

A comparison of example 5 with comparative example 6 shows that the branched polyethercarbonate polyols from example 5 which was prepared using glycidol has a lower viscosity and a higher reactivity in the case of crosslinking with isocyanates compared to the mixture from example 6 which was prepared using starter compounds of different functionality.

### Example 7

### Preparation of a Branched Polyethercarbonate Polyol of Theoretical Functionality 3.0, Proceeding from a Starter Compound of Functionality 2.0, Using Glycidol as Branching Compound to Increase the Functionality

A 300 mL pressure reactor equipped with a sparging stirrer was initially charged with a mixture of DMC catalyst (22 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 80.73 g of propylene oxide were metered in by means of an HPLC pump (1 mL/min) while stirring, while continuing to stir the reaction mixture (800 rpm). Fifteen minutes after commencement of the addition of propylene oxide, 2.96 g of glycidol were metered in by means of a separate HPLC pump (0.15 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 6.4.

No accumulation of glycidol in the reaction mixture was obtained.

The NMR spectroscopy analysis of the reaction mixture showed full conversion of the propylene oxide and the glycidol.

The selectivity c/l was 0.07.

The molar ratio of carbonate groups to ether groups in the polymer e/f was 18.8/81.2.

The weight- and number-average molecular weight of the polyethercarbonate obtained, determined via GPC, was Mₙ=1928 g/mol, M_{w}=2678 g/mol; the polydispersity was 1.3.

The OH number of the resulting mixture was 60.7 mg_{KOH}/g.

The viscosity of the resulting mixture was 2430 mPa s.

The time until the attainment of the gel point was 5.1 min.

### Example 8

### Comparative Example

### Preparation of a Polyethercarbonate Having a Functionality of 3 Using a Trifunctional Starter Compound

A 300 ml, pressure reactor equipped with a sparging stirrer was initially charged with a mixture of DMC catalyst (20.1 mg) and PET-2 (16.8 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.65 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.65 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. After cooling to 100° C., 79.2 g of propylene oxide were metered in by means of an HPLC pump (1 mL/min), while continuing to stir the reaction mixture (800 rpm) [step (δ)]. After the addition of propylene oxide had ended, the reaction mixture was stirred at 1.00° C. for a further 2 h. The reaction was ended by cooling the reactor in an ice bath, the elevated pressure was released and the resulting product was analyzed.

No glycidol was metered in.

The NMR spectroscopy analysis of the reaction mixture showed full conversion of the propylene oxide.

The selectivity c/l was 0.11.

The molar ratio of carbonate groups to ether groups in the polymer e/f was 18.4/81.6.

The weight- and number-average molecular weight of the polyethercarbonate obtained, determined via GPC, was Mₙ=4118 g/mol, M_{w}=5200 g/mol; the polydispersity was 1.3.

The OH number of the resulting mixture was 57.1 mg_{KOH}/g.

The viscosity of the resulting mixture was 2969 mPa s.

The time until the attainment of the gel point was 6.3 min.

Comparison of a Polyethercarbonate Polyol Prepared by the Process of the Invention with a Polyethercarbonate Polyol Obtained by Using a Mixture of Starter Compounds of Different Functionality:

| | Functionality | Viscosity | Gel point |
|---|---|---|---|
| Example | of the product | mPa · s | min |
| 7 | 3 | 2430 | 5.1 |
| 8 (comp.) | 3 | 2969 | 6.3 |

comp.: comparative example

A comparison of example 7 with comparative example 8 shows that the branched polyethercarbonate polyol from example 7 which was prepared using glycidol has a lower viscosity and a higher reactivity in the case of crosslinking with isocyanates compared to the mixture from example 8 which was prepared using starter compounds of different functionality.

### Example 9

### Comparative Example

### Preparation of a Branched Polyethercarbonate Polyol of Theoretical Functionality 3.0, Proceeding from a Starter Compound of Functionality 2.0, Using Glycidol as Branching Compound to Increase the Functionality with Elevated Addition Rate of Glycidol During Step (γ)

A 300 mL pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time continued the activation of the catalyst [step (β)]. The temperature was kept at 100° C. by closed-loop control and, during the subsequent steps, the pressure in the reactor was kept at 15 bar by metering in further CO₂. On attainment of 100° C., a further 97.24 g of propylene oxide were metered in by means of an HPLC pump (1 mL/mini) while stirring, while continuing to stir the reaction mixture (800 rpm). Fifteen minutes after commencement of the addition of propylene oxide, 2.98 g of glycidol were metered in by means of a separate HPLC pump (10 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 0.1.

The proportion of glycidol metered in at the time at which the addition of glycidol was ended was 7.8% by weight (2.98 g of glycidol based on the sum total of 17.4 g of starter compound, 3×1.75 g of propylene oxide, 12.7 g of propylene oxide from step (γ) and 2.98 g of glycidol).

The NMR spectroscopy analysis of the reaction mixture showed that the predominant portion of the propylene oxide used and the glycidol had not been converted. The desired polymer was not obtained.

Comparison of the Preparation of Polyethercarbonate Polyols with Variation of the Addition Rate of the Glycidol:

| | Addition rate | Viscosity | Gel point |
|---|---|---|---|
| Example | ml · min | mPa · s | min |
| 7 | 0.15 | 2430 | 5.1 |
| 9 (comp.) | 10.0 | — | — |

comp.: comparative example

A comparison of example 7 with comparative example 9 shows that no product is obtained when the addition rate of glycidol is excessively high.

### Example 10

### Comparative Example

### Preparation of a Branched Polyethercarbonate Polyol of Theoretical Functionality 3.0, Proceeding from a Starter Compound of Functionality 2.0, Using Glycidol as Branching Compound to Increase the Functionality with Addition of Glycidol During Step (β)

A 300 mL pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and 0.98 g of glycidol via a separate HPLC pump (0.43 mL/min), and the reaction mixture was stirred (800 rpm) for 20 mm. The occurrence of a brief increase in evolution of heat in the reactor during this time indicated the activation of the catalyst. Subsequently, two further portions each of 1.75 g of propylene oxide were metered in by means of the HPLC pump (1 mL/min) and simultaneously 0.98 g of glycidol via a separate HPLC pump (0.43 mL/min), and the reaction mixture was stirred for 20 min (800 rpm) after each addition. The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 97.38 g of propylene oxide were metered in by means of an HPLC pump (1 mL/min) while stirring, while continuing to stir the reaction mixture (800 rpm). Fifteen minutes after the addition of propylene oxide and glycidol had ended, the reaction mixture was stirred at 100° C. for a further 2 h. The reaction was ended by cooling the reactor in an ice bath, the elevated pressure was released and the resulting product was analyzed.

The addition of glycidol was effected in step (β). The molar ratio of the addition rate of propylene oxide to the addition rate of glycidol was 2.2.

The proportion of glycidol metered in at the end of step (β) was 11.5% by weight (3×0.98 g of glycidol based on the sum total of 17.4 g of starter compound, 3×1.75 g of propylene oxide and 3×0.98 g of glycidol).

The NMR spectroscopy analysis of the reaction mixture showed that the propylene oxide used and the glycidol had not been converted.

Comparison of the Preparation of Polyethercarbonate Polyols with Variation of the Juncture of Addition of Glycidol:

| | Time of | Viscosity | Gel point |
|---|---|---|---|
| Example | addition | mPa · s | min |
| 7 | in step (γ) | 2430 | 5.1 |
| 10 (comp.) | in step (β) | — | — |

comp.: comparative example

A comparison of example 7 with comparative example 10 shows that no product is obtained when glycidol is added during the activation phase of the catalyst (step (β)).

### Example 11

### Comparative Example

### Preparation of a Branched Polyethercarbonate Polyol of Theoretical Functionality 3.0, Proceeding from a Starter Compound of Functionality 2.0, Using Glycidol as Branching Compound to Increase the Functionality Without Addition of an Alkylene Oxide

A 300 ml, pressure reactor equipped with a sparging stirrer was initially charged with a mixture of DMC catalyst (32 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 0.18 g of glycidol was metered in with the aid of an HPLC pump (0.03 mL/min) and the reaction mixture was stirred (800 rpm) for 20 min. The occurrence of a brief increase in evolution of heat in the reactor during this time indicated the activation of the catalyst. Subsequently, two further portions each of 0.18 g of glycidol were metered in by means of the HPLC pump (0.03 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 2.44 g of glycidol were metered in by means of an HPLC pump (0.03 mL/min) while stirring, while continuing to stir the reaction mixture (800 rpm). Fifteen minutes after the addition of glycidol had ended, the reaction mixture was stirred at 100° C. for a further 2 h. The reaction was ended by cooling the reactor in an ice bath, the elevated pressure was released and the resulting product was analyzed.

No propylene oxide was metered in.

The proportion of glycidol metered in at the end of step (β) was 14.6% by weight (3×0.18 g plus 2.44 g of glycidol based on the sum total of 17.4 g of starter compound and 3×0.18 g plus 2.44 g of glycidol).

The NMR spectroscopy analysis of the reaction mixture showed that the glycidol used had not been converted.

Comparison of the Preparation of Polyethercarbonate Polyols with Variation of the Amount of Glycidol Used:

| | Alkylene oxides and | Viscosity | Gel point |
|---|---|---|---|
| Example | branching compounds used | mPa · s | min |
| 7 | PO and glycidol | 2430 | 5.1 |
| 11 (comp.) | Glycidol | — | — |

comp.: comparative example

A comparison of example 7 with comparative example 11 shows that no product is obtained when glycidol is used without simultaneous addition of an alkylene oxide.

### Example 12

### Preparation of a Branched Polyethercarbonate Polyol of Theoretical Functionality 4, Proceeding from a Starter Compound of Functionality 2.0, Using Glycerol Diglycidyl Ether as Branching Compound to Increase the Functionality

A 300 ml, pressure reactor equipped with a sparging stirrer was initially charged with a mixture of DMC catalyst (26 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 104.2 g of propylene oxide were metered in by means of an HPLC pump (1 mL/min) while stirring, while continuing to stir the reaction mixture (800 rpm). Fifteen minutes after commencement of the addition of propylene oxide, 4.4 g of glycerol diglycidyl ether were metered in by means of a separate HPLC pump (0.09 mL/min) while stirring [step (γ)]. After the addition of propylene oxide and glycerol diglycidyl ether had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycerol diglycidyl ether was 28.2.

No accumulation of glycerol diglycidyl ether in the reaction mixture was obtained.

The NMR spectroscopy analysis of the reaction mixture showed full conversion of the propylene oxide and the glycerol diglycidyl ether.

The selectivity c/l was 0.06.

The molar ratio of carbonate groups to ether groups in the polymer e/f was 22.5/77.5.

The weight- and number-average molecular weight of the polyethercarbonate obtained, determined via GPC, was Mₙ=4489 g/mol, M_{w}=8558 g/mol; the polydispersity was 1.9.

The OH number of the resulting mixture was 31.3 mg_{KOH}/g.

The viscosity of the resulting mixture was 19 700 mPa s.

The time until the attainment of the gel point was 8.0 mm.

### Example 13

### Preparation of a Branched Polyethercarbonate Polyol of Theoretical Functionality 3, Proceeding from a Starter Compound of Functionality 2.0, Using 3-ethyl-3-oxetanemethanol as Branching Compound to Increase the Functionality

A 300 mL pressure reactor equipped with a sparging stirrer was initially charged with a mixture of DMC catalyst (36 mg) and PET-1 (17.4 g), and the mixture was stirred (800 rpm) under a slight vacuum (50 mbar) and a gentle Ar stream at 130° C. for 30 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 1.75 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 1.75 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 132.56 g of propylene oxide were metered in by means of an HPLC pump (1 mL/min) while stirring, while continuing to stir the reaction mixture (800 rpm). Fifteen minutes after commencement of the addition of propylene oxide, 4.66 g of 3-ethyl-3-oxetanemethanol were metered in by means of a separate HPLC pump (0.09 mL/min) while stirring [step (γ)]. After the addition of propylene oxide and 3-ethyl-3-oxetanemethanol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of 3-ethyl-3-oxetanemethanol was 18.1.

No accumulation of 3-ethyl-3-oxetanemethanol in the reaction mixture was obtained.

The NMR spectroscopy analysis of the reaction mixture showed full conversion of the propylene oxide and the 3-ethyl-3-oxetanemethanol.

The selectivity c/l was 0.11.

The molar ratio of carbonate groups to ether groups in the polymer e/f was 18.5/81.5.

The weight- and number-average molecular weight of the polyethercarbonate obtained, determined via GPC, was Mₙ=2793 g/mol, M_{w}=4038 g/mol, and the polydispersity was 1.4.

The OH number of the resulting mixture was 40.1 mg_{KOH}/g.

The viscosity of the resulting mixture was 2423 mPa s.

The time until the attainment of the gel point was 16.2 min.

### Example 14

### Preparation of a Branched Polyethercarbonate Polyol of Theoretical Functionality 3.0, Proceeding from a Difunctional Acid as Starter Compound, Using Glycidol as Branching Compound to Increase the Functionality

A 300 mL pressure reactor equipped with a sparging stirrer was initially charged with a mixture of DMC catalyst (120 mg) and hydrogenated dimer fatty acid (22.8 g), and the mixture was stirred (800 rpm) under a slight vacuum (50 mbar) and a gentle Ar stream at 130° C. for 45 min [step (α)]. CO₂ was injected to 15 bar, which caused the temperature in the reactor to drop slightly. The temperature was kept at 130° C. by closed-loop control and, during the subsequent steps, the pressure in the reactor was kept at 15 bar by metering in further CO₂. 2.3 g of propylene oxide were metered in with the aid of an HPLC pump (1 mL/min) and the reaction mixture was stirred (800 rpm) for 20 min. The occurrence of a brief increase in evolution of heat in the reactor during this time indicated the activation of the catalyst. Subsequently, two further portions each of 2.3 g of propylene oxide were metered in by means of the HPLC pump (1 mL/min) and the reaction mixture was stirred for 20 min (800 rpm). The occurrence of a brief increase in evolution of heat in the reactor during this time confirmed the activation of the catalyst [step (β)]. The temperature was kept at 100° C. by closed-loop control and, during the subsequent steps, the pressure in the reactor was kept at 15 bar by metering in further CO₂. On attainment of 100° C., a further 135.75 g of propylene oxide were metered in by means of an HPLC pump (1 mL/min) while stirring, while continuing to stir the reaction mixture (800 rpm). Fifteen minutes after commencement of the addition of propylene oxide, 2.98 g of glycidol were metered in by means of a separate HPLC pump (0.09 mL/min) while stirring [step (γ)]. After the addition of propylene oxide and glycidol had ended, the reaction mixture was stirred at 100° C. for a further 2 h. The reaction was ended by cooling the reactor in an ice bath, the elevated pressure was released and the resulting product was analyzed.

The molar ratio of the addition rate of propylene oxide to the addition rate of glycidol was 10.6.

No accumulation of glycidol in the reaction mixture was obtained.

The NMR spectroscopy analysis of the reaction mixture showed full conversion of the propylene oxide and the glycidol.

The selectivity c/l was 0.38.

The molar ratio of carbonate groups to ether groups the polymer e/f was 16.7/83.3.

The weight- and number-average molecular weight of the polyethercarbonate obtained, determined via GPC, was Mₙ=2585 g/mol, M_{w}=3688 g/mol; the polydispersity was 1.4.

The OH number of the resulting mixture was 47.6 mg_{KOH}/g.

The viscosity of the resulting mixture was 3577 mPa s.

The time until the attainment of the gel point was 12.7 min.

Comparison of the Preparation of Polyethercarbonate Polyols by the Process of the Invention Using Different Branching Compounds:

| | Starter | Branching | | | Gel |
|---|---|---|---|---|---|
| | compound | compounds | Function- | Viscosity | point |
| Example | used | used | ality F | mPa · s | min |
| 7 | PET-1 | Glycidol | 3 | 2430 | 5.1 |
| 12 | PET-1 | Glycerol | 4 | 19 700 | 8.0 |
| | | diglycidyl | | | |
| | | ether | | | |
| 13 | PET-1 | 3-Ethyl-3- | 3 | 2423 | 16.2 |
| | | oxetanemeth- | | | |
| | | anol | | | |
| 14 | Dimer | Glycidol | 3 | 3577 | 12.7 |
| | fatty | | | | |
| | acid | | | | |

Examples 7 and 12 to 14 show that branched polyethercarbonates of different functionality can be obtained using different starter compounds and different branching compounds.

1.-15. (canceled)

16. A process for preparing branched polyethercarbonate polyols, comprising the step of reacting an alkylene oxide and carbon dioxide with an H-functional starter compound in the presence of a catalyst,
wherein the reaction is additionally conducted in the presence of a branching compound comprising a functional group polymerizable by ring opening and an H-functional group and
wherein the branching compound is added during the reaction in such a way that the proportion of branching compound in the reaction mixture obtained is ≦7.5% by weight at any time during the addition, based on the amount of H-functional starter compound, alkylene oxide and branching compound added at this time.

17. The process as claimed in claim 16, comprising the steps of:
(α) initially charging the catalyst and:
a suspension medium which contains no H-functional groups and/or
the H-functional starter compound
(γ) metering in carbon dioxide, the alkylene oxide and the branching compound,
wherein, additionally, if no H-functional starter compound has been initially charged in step (α), step (γ) comprises the metering-in of the H-functional starter compound.

18. The process as claimed in claim 17, further comprising step (β) between step (α) and step (γ):
(β) metering in an alkylene oxide which is the same as or different than the alkylene oxide which is used in step (γ).

19. The process as claimed in claim 16, wherein the addition of the branching compound is complete before 50 mol % of the total amount of the alkylene oxide in this reaction has been added.

20. The process as claimed in claim 16, wherein the addition of the branching compound is commenced after 50 mol % of the total amount of the alkylene oxide in this reaction has been added.

21. The process as claimed in claim 17, wherein at least step (γ) is conducted continuously.

22. The process as claimed in claim 17, wherein step (γ) comprises a continuous metered-addition of the H-functional starter compound.

23. The process as claimed in claim 17, wherein step (γ) comprises a discontinuous metered addition of the H-functional starter compound.

24. The process as claimed in claim 16, wherein the alkylene oxide used is ethylene oxide and/or propylene oxide.

25. The process as claimed in claim 16, wherein the starter compound used comprises polyether polyols and/or oligomerized fatty acids.

26. The process as claimed in claim 16, wherein the catalyst is a DMC catalyst.

27. The process as claimed in claim 16, wherein the branching compound is selected from the group consisting of glycidyl alcohols, oxetane alcohols, monoglycidyl ethers of diols, mono- or diglycidyl ethers of triols, unsubstituted or substituted 3-hydroxyalkyloxetanes, compounds of the following formula: 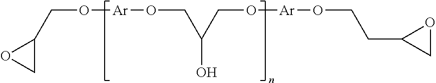
where Ar is a divalent aromatic, araliphatic, cycloaliphatic or aliphatic radical which has 5 to 22 carbon atoms and optionally comprising heteroatoms and n is a natural number from 1 to 10, and mixtures thereof.

28. The process as claimed in claim 16, wherein the polyethercarbonate polyol obtained is reacted with di- and/or polyisocyanates in an additional subsequent process step.

29. A polyethercarbonate polyol obtained by the process as claimed in claim 16.

30. A crosslinked polyethercarbonate polymer obtained by the process as claimed in claim 28.
